(19) United States
(12) Patent Application Publication
(10) Pub. No.: US 2010/0039356 A1
(43) Pub. Date: Feb. 18, 2010

(54) Driving Method of Display Device

(75) Inventor: Hajime Kimura, Atsugi (JP)

Correspondence Address: COOK ALEX LTD, SUITE 2850, 200 WEST ADAMS STREET, CHICAGO, IL, 60606, US

(73) Assignee: Semiconductor Energy Laboratory Co., Ltd.

(21) Appl. No.: 12/603,314

(22) Filed: Oct. 21, 2009

Related U.S. Application Data
(63) Continuation of application No. 11/300,975, filed on Dec. 15, 2005.

(30) Foreign Application Priority Data
Dec. 28, 2004 (JP) 2004-380196

(51) Int. Cl. G09G 3/30

(52) U.S. Cl. 345/77

(57) ABSTRACT

In a display device for displaying gray scales by dividing one frame into a plurality of subframes and using a time gray scale method, pseudo contour is generated. In the case where high-order bits are displayed, gray scales are displayed by sequentially adding the weight (light-emitting period, the frequency of light emission, and the like) of each subframe. Similarly, in the case where low-order bits are displayed, gray scales are displayed by sequentially adding the weight (light-emitting period, the frequency of light emission, and the like) of each subframe. The subframes for the high-order bits and the subframes for the low-order bits are arranged so as not to be concentrated at one portion in one frame.

### BACKGROUND OF THE INVENTION

1. Field of the Invention

The present invention relates to a display device and a driving method thereof, especially, a display device to which a time gray scale method is applied.

2. Description of the Related Art

In recent years, a so-called self-light emitting display device having a pixel which is formed of a light-emitting element such as a light-emitting diode (LED) has attracted a great deal of attention. As a light-emitting element used for such a self-light emitting display device, an organic light-emitting diode (OLED) (also referred to as an organic EL element, and electroluminescence (EL) element) attracts attentions, and they have been used for an EL display and the like. A light-emitting element such as an OLED is self-luminous, therefore, it has advantages such as higher visibility of pixels, no backlight, higher response compared to a liquid crystal display. The luminance of a light-emitting element is controlled by a current value flowing in the light-emitting element.

As a driving method of controlling light emission gray scales of such a display device, there are a digital gray-scale method and an analog gray-scale method. By the digital gray-scale method, a light-emitting element is turned on/off by controlling in a digital manner so as to display gray scales. On the other hand, as the analog gray-scale method, there are a method of controlling the emission intensity of a light-emitting element in an analog manner, and a method of controlling the emission time of a light-emitting element in an analog manner.

In the case of the digital gray-scale method, there are only two states of a light emitting state and a non-light emitting state so that only two gray scales can be displayed. Therefore, a multi-gray scale is achieved by combining with another method. A time gray-scale method is often used for achieving a multi-gray scale.

Some display devices which display gray scales by controlling a display state of a pixel in a digital manner and a time gray scale are given such as a plasma display as well as an organic EL display using a digital gray scale method.

A time gray scale method is a method for displaying gray scales by controlling the length of a light-emitting period and the frequency of light emission. That is, one frame period is divided into a plurality of subframe periods, each of which has a weighted frequency of light emission, a weighted light-emitting period, or the like. The total weight (the sum of the frequency of light emission or the light-emitting period) is differentiated with respect to each gray scale level, thereby gray scales are displayed. It is known that a display defect called pseudo contour (fake contour) is generated when such a time gray scale method is used. Therefore, the solution of the problem has been studied (see Patent Documents 1 to 7).

### [Patent Document 1] Japanese Patent No. 2903984

### [Patent Document 2] Japanese Patent No. 3075335

### [Patent Document 3] Japanese Patent No. 2639311

### [Patent Document 4] Japanese Patent No. 3322809

### [Patent Document 5] Japanese Patent Laid-Open No. hei 10-307561

### [Patent Document 6] Japanese Patent No. 3585369

### [Patent Document 7] Japanese Patent No. 3489884

Although various methods of reducing pseudo contour are thus suggested, a sufficient effect has not been obtained yet.

For example, FIG. 1 of Patent Document 2 is referred to. A gray scale level of 127 is displayed in a pixel A, and a gray scale level of 128 is displayed in an adjacent pixel B. A light emitting state or a non-light emitting state in each subframe in this case is shown in FIG. 32. In the case where only the pixel A or B is watched without looking away, pseudo contour is not generated. This is because the sum of luminance in areas where eyes move is visible to eyes. Therefore, in the pixel A, a gray scale level of 127 (=1+2+4+8+16+32+32+32) is visible along a line of sight 3201, and in the pixel B, a gray scale level of 128 (=32+32+32+32) is visible along a line of sight 3202. That is to say, an accurate gray scale level is visible to eyes.

On the other hand, it is assumed that the line of sight moves from the pixel A to the pixel B or from the pixel B to the pixel A as shown in FIG. 33. In such a case, a gray scale level of 96 (=32+32+32) is visible along a line of sight 3301, and a gray scale level of 159 (=1+2+4+8+16+32+32+32+32) is visible along a line of sight 3302. Although gray scale levels of 127 and 128 should be visible, gray scale levels of 96 to 159 are actually visible. Consequently, pseudo contour is generated.

FIGS. 32 and 33 show a case of 8 bits (256 gray scales). Subsequently, FIG. 34 shows a case of 5 bits. In this case, similarly, a gray scale level of 12 (=4+4+4) is visible along a line of sight 3401, and a gray scale level of 19 (=1+2+4+4+4+4) is visible along a line of sight 3402. Although gray scale levels of 15 and 16 should be visible, gray scale levels of 12 to 19 are actually visible. Consequently, pseudo contour is generated.

Similarly, FIG. 1 of Patent Document 3 is referred to. The pixel A displays a gray scale level of 31, and an adjacent pixel B displays a gray scale level of 32. A light-emitting state or a non-light emitting state in each subframe in this case is shown in FIG. 35. In the case where only the pixel A or B is watched without looking away, pseudo contour is not generated. This is because the sum of luminance in areas where eyes move is visible to eyes. Therefore, in the pixel A, a gray scale level of 31 (=16+4+4+4+1+1+1) is visible along a line of sight 3501, and in the pixel B, a gray scale level of 32 (=16+16) is visible along a line of sight 3502. That is to say, an accurate gray scale level is visible to eyes.

On the other hand, it is assumed that the line of sight moves from the pixel A to the pixel B or from the pixel B to the pixel A as shown in FIG. 36. In such a case, a gray scale level of 16 (=16) is visible along a line of sight 3602, and a gray scale level of 47 (=16+16+4+4+4+1+1+1) is visible along a line of sight 3601. Although gray scale levels of 31 and 32 should be visible, gray scale levels to be 16 to 47 are actually visible. Consequently, pseudo contour is generated.

### SUMMARY OF THE INVENTION

The present invention is made in view of the abovementioned problems to provide a display device which can reduce pseudo contour and displays by using less subframes, and a driving method thereof.

In the present invention, in the case of displaying high-order bits (that is, high numerical position of bits such as MSB (Most Significant Bit)) of a gray scale displayed as a binary number, the gray scales is displayed by sequentially adding the weight (light-emitting period and the frequency of light emission) in each subframe. Further, in the case of displaying low-order bits (that is, low numerical position of bits such as LSB (Least Significant Bit)) of a gray scale as a binary number, the gray scale is displayed by sequentially adding the weight (light-emitting period and the frequency of light emission) in each subframe. In addition, subframes for high-order bits and subframes for low-order bits are arranged so as not to be concentrated at one portion in one frame. For example, the subframes for low-order bits are sandwiched between the subframes for high-order bits. By displaying the gray scale using such a method, the abovementioned objects are achieved.

The invention provides a driving method of a display device for displaying gray scales by dividing one frame into a plurality of subframes, which includes performing approximately equally weighting with respect to the light emission of a plurality of subframes corresponding to high-order bits of the gray scales displayed as a binary number, and performing approximately equally weighting with respect to the light emission of one or more subframes corresponding to low-order bits of the gray scales displayed as a binary number, wherein light is emitted in one of the plurality of subframes corresponding to the high-order bits, light is emitted in one of the one or more subframes corresponding to the low-order bits, and light is emitted in another one of the plurality of subframes corresponding to the high-order bits.

The invention provides a driving method of a display device for displaying gray scales by dividing one frame into a plurality of subframes, which includes performing approximately equally weighting with respect to the light emission of a plurality of subframes corresponding to high-order bits of the gray scales displayed as a binary number, and performing approximately equally weighting with respect to the light emission of one or more subframes corresponding to low-order bits of the gray scales displayed as a binary number, wherein light is emitted in one of the plurality of subframes corresponding to the low-order bits, light is emitted in one of the plurality of subframes corresponding to the high-order bits, and light is emitted in another one of the plurality of subframes corresponding to the low-order bits.

The invention provides a driving method of a display device for displaying gray scales by dividing one frame into a plurality of subframes, which includes performing approximately equally weighting with respect to the light emission of a plurality of subframes corresponding to high-order bits of the gray scales displayed as a binary number, and performing approximately equally weighting with respect to the light emission of one or more subframes corresponding to low-order bits of the gray scales displayed as a binary number, wherein light is emitted in one of the plurality of subframes corresponding to the low-order bits emits light, light is emitted in at least two of the plurality of subframes corresponding to the high-order bits emit light, and light is emitted in another one of a plurality of subframes corresponding to the low-order bits.

The invention provides a driving method of a display device for displaying gray scales by dividing one frame into a plurality of subframes, which includes performing approximately equally weighting with respect to the light emission of a plurality of subframes corresponding to high-order bits of the gray scales displayed as a binary number, and performing approximately equally weighting with respect to the light emission of one or more subframes corresponding to low-order bits of the gray scales displayed as a binary number, wherein light is emitted in one of the plurality of subframes corresponding to the high-order bits, light is emitted in at least two of the plurality of subframes corresponding to the low-order bits, and light is emitted in another one of the plurality of subframes corresponding to the high-order bits.

The invention provides a driving method of a display device for displaying gray scales by dividing one frame into a plurality of subframes, which includes performing approximately equally weighting with respect to the light emission of a plurality of subframes corresponding to high-order bits of the gray scales displayed as a binary number, and performing approximately equally weighting with respect to the light emission of one or more subframes corresponding to low-order bits of the gray scales displayed as a binary number, wherein the plurality of subframes corresponding to the high-order bits or the low-order bits, which has a smaller number of bits are provided between subframes selected from the plurality of subframes corresponding to the high-order bits or the low-order bits, which has a larger number of bits.

A transistor used in the invention is not particularly limited, and may be a thin film transistor (TFT) using a non-monocrystalline semiconductor film represented by amorphous silicon or polycrystalline silicon, a MOS transistor formed by using a semiconductor substrate or an SOI substrate, a junction transistor, a bipolar transistor, a transistor using an organic semiconductor or a carbon nanotube, or the like. Furthermore, a substrate on which a transistor is mounted is not exclusively limited to a certain type. A transistor may be formed on a single crystalline substrate, an SOI substrate, a glass substrate, a plastic substrate and the like.

Note that in the invention, the term “connected” means that something is electrically connected. Therefore, in a structure disclosed in the invention, other elements which enable an electrical connection (for example, another element or a switch) may be arranged between a prescribed connection.

Additionally, “approximately equally weighting” indicates that a weighted frequency of light emission or a weighted light-emitting period or the like in each of subframes may have a difference which cannot be recognized by human eyes. Although a range of the difference differs depending on the number of bits used for displaying and a gray scale level of displaying, for example, even if each of subframes has a difference of 3 gray scale levels, “approximately equally weighting” is deemed to be performed in the case where 64 gray scales are used for displaying.

According to the present invention, pseudo contour can be reduced. Therefore, image quality is improved so that a clear image can be displayed.

### BRIEF DESCRIPTION OF THE DRAWINGS

FIG. 1 is a table showing a structure of a driving method of a display device using the invention.

FIG. 2 is a table showing a structure of a driving method of a display device using the invention.

FIG. 3 is a table showing a structure of a driving method of a display device using the invention.

FIG. 4 is a table showing a structure of a driving method of a display device using the invention.

FIG. 5 is a table showing a structure of a driving method of a display device using the invention.

FIG. 6 is a table showing a structure of a driving method of a display device using the invention.

FIG. 7 is a table showing a structure of a driving method of a display device using the invention.

FIG. 8 is a table showing a structure of a driving method of a display device using the invention.

FIG. 9 is a view showing a structure of a driving method of a display device using the invention.

FIG. 10 is a view showing a structure of a driving method of a display device using the invention.

FIG. 11 is a view showing a structure of a driving method of a display device using the invention.

FIG. 12 is a view showing a structure of a driving method of a display device using the invention.

FIG. 13 is a table showing a structure of a driving method of a display device using the invention.

FIG. 14 is a view showing a structure of a driving method of a display device using the invention.

FIG. 15 is a diagram showing a structure of a display device using the invention.

FIG. 16 is a view showing a structure of a driving method of a display device using the invention.

FIG. 17 is a diagram showing a structure of a display device using the invention.

FIG. 18 is a view showing a structure of a driving method of a display device using the invention.

FIG. 19 is a view showing a structure of a driving method of a display device using the invention.

FIG. 20 is a diagram showing a structure of a display device using the invention.

FIG. 21 is a diagram showing a structure of a display device using the invention.

FIG. 22 is a diagram showing a structure of a display device using the invention.

FIG. 23 is a view showing a structure of a display device using the invention.

FIG. 24 is a view showing a structure of a display device using the invention.

FIG. 25 is a view showing a structure of a display device using the invention.

FIG. 26 is a view showing a structure of a display device using the invention.

FIG. 27 is a view showing an electronic appliance using the invention.

FIGS. 28A and 28B are views showing a structure of a display device using the invention.

FIG. 29 is a view showing an electronic appliance using the invention.

FIG. 30 is a view showing a structure of a display device using the invention.

FIGS. 31A to 31H are views showing electronic appliances using the invention.

FIG. 32 is a view showing a structure of a driving method of a display device using the invention.

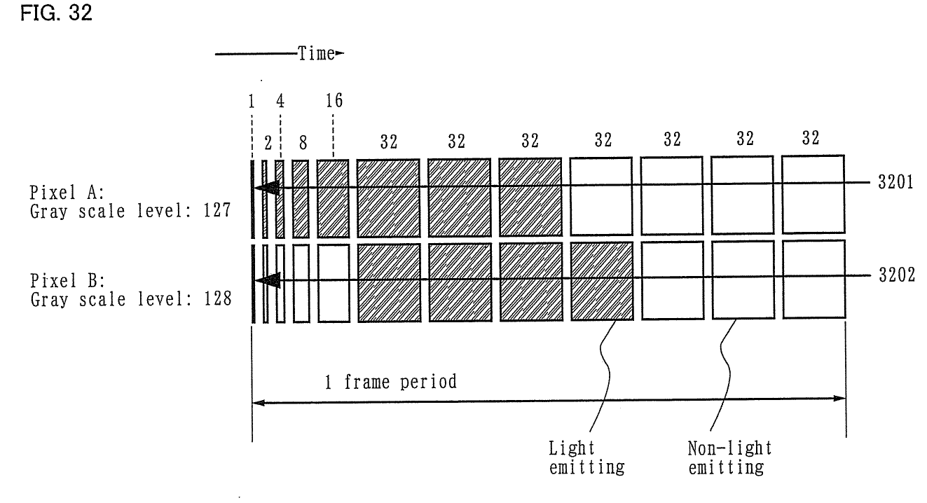

FIG. 33 is a view showing a structure of a driving method of a display device using the invention.

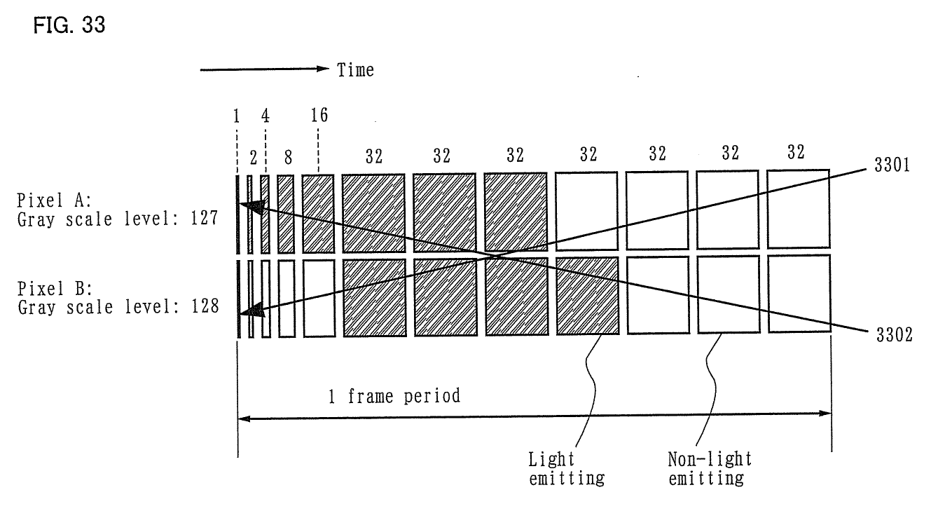

FIG. 34 is a view showing a structure of a driving method of a display device using the invention.

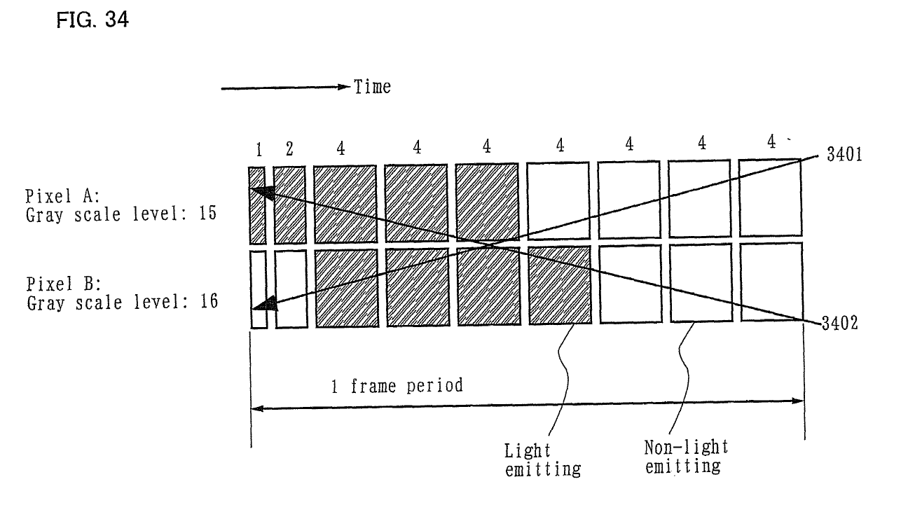

FIG. 35 is a view showing a structure of a driving method of a display device using the invention.

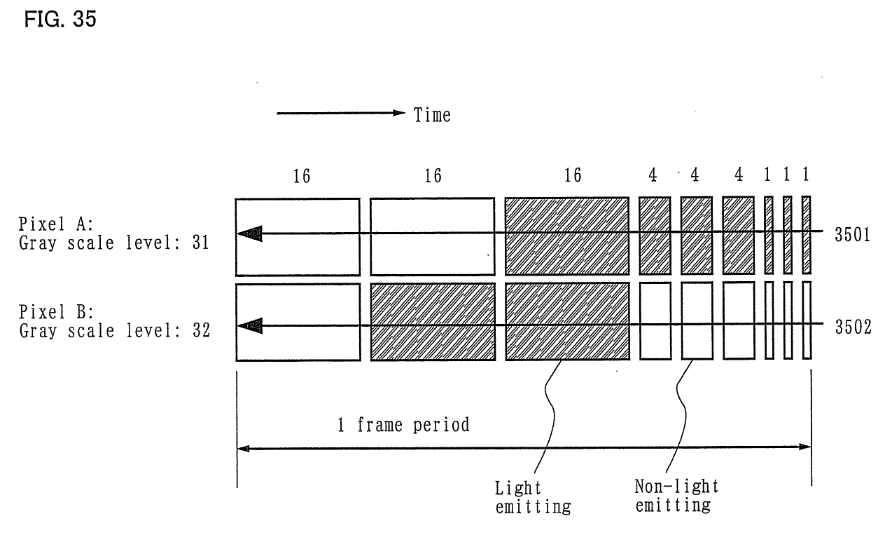

FIG. 36 is a view showing a structure of a driving method of a display device using the invention.

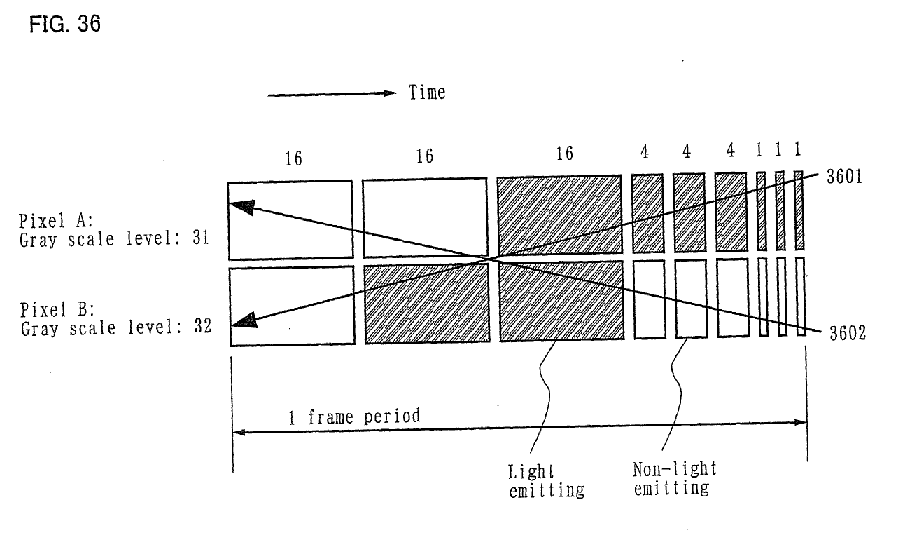

### DETAILED DESCRIPTION OF THE INVENTION

Although the invention will be fully described by way of embodiment modes and embodiments with reference to the accompanying drawings, it is to be understood that various changes and modifications will be apparent to those skilled in the art. Therefore, unless otherwise such changes and modifications depart from the scope of the invention, they should be construed as being included therein.

### Embodiment Mode 1

For example, a case of displaying 5-bit gray scale is considered here. That is, description is made on a case of 32 gray scales. First, gray scales to be displayed (here, 5 bits) are divided into high-order bits and low-order bits, for example, the high-order 3 bits and the low-order 2 bits.

In the present invention, gray scales are displayed by sequentially adding the light-emitting period of each subframe (or the frequency of light emission in a certain period) in each region (here, high-order bits and low-order bits) where gray scales are divided. That is, as a gray scale level is increased, light is emitted in more subframes. Therefore, in a subframe where light is emitted when a gray scale level is low, light is emitted when a gray scale level is high. Such a gray scale method is referred to as an overlapping time gray scale method. This method is used in each region where gray scales are divided. Accordingly, all the gray scales are displayed.

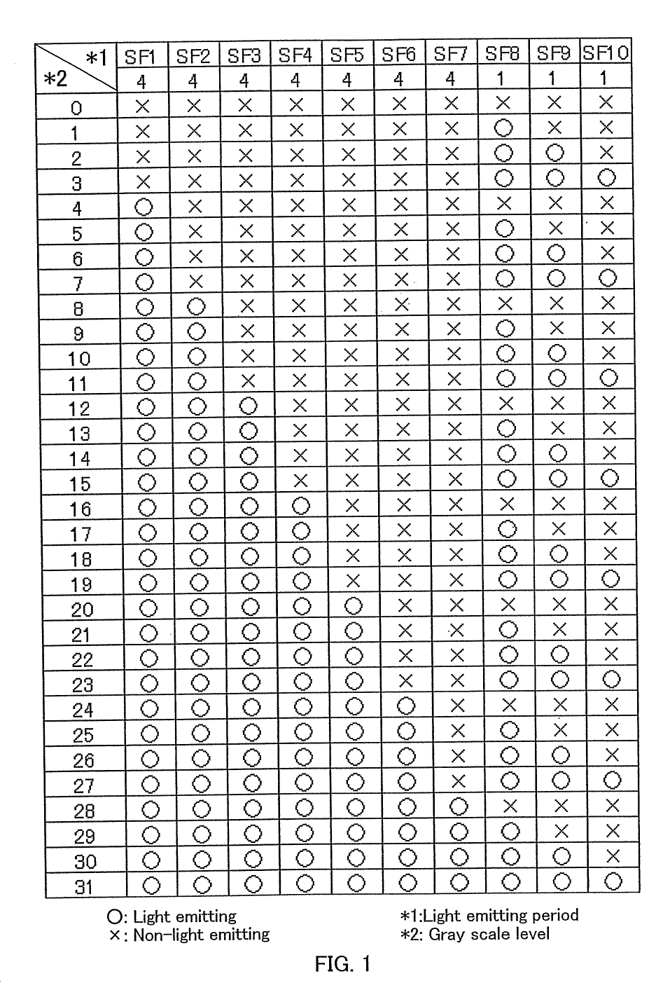

Subsequently, description is made on a method of selecting a subframe in each gray scale level, that is, a method for selecting a subframe in which light is emitted in each gray scale level. FIG. 1 shows a method of selecting a subframe in the case where 5-bit gray scale is displayed while dividing into high-order 3 bits and low-order 2 bits. The high-order bits are displayed using 7 subframes (SF1 to SF7). Accordingly, 3-bit gray scale, that is, 8 gray scales can be displayed. The length of each light-emitting period is set to 4. Here, a gray scale level of 1 corresponds to the length of a light-emitting period of 1. The low-order bits are displayed using 3 subframes (SF8 to SF10). Accordingly, 2-bit gray scale, that is, 4 gray scales can be displayed. The length of each light-emitting period is all 1. Thus, 5-bit gray scale can be displayed by 10 subframes including 7 subframes for the high-order bits and 3 subframes for the low-order bits.

Note that, although the length of each light emitting period in the subframes for the high-order bits (or the frequency of light emission in a certain period, that is, a weighted amount) is all 4, and the length of each light emitting period in the subframes for the low-order bits (or the frequency of light emission in a certain period, that is a weighted amount) is all 1, the invention is not limited to this. The length of a light-emitting period (or the frequency of light emission in a certain period, that is, a weighted amount) may be different in each subframe.

For example, a light emitting period in some subframes for the high-order bits may be divided and the number of subframes may be increased. For example, a subframe having a light-emitting period of 4 may be divided into two subframes each having a light-emitting period is of 2, or into a subframe having a light-emitting period of 1 and a subframe having a light-emitting period of 3.

Note that gray scales are displayed in accordance with a light-emitting period in the case where light is emitted continuously, and gray scales are displayed in accordance with the frequency of light emission in the case where light is repeatedly turned on and off in a certain period. A display device which displays gray scales in accordance with the frequency of light emission is typified by a plasma display. A display device which displays gray scales in accordance with a light-emitting period is typified by an organic EL display.

Here, description is made on FIG. 1. Light is emitted in a subframe with a circle, and no light is emitted in a subframe with a cross. Gray scales are displayed by selecting a subframe in which light is emitted. For example, in the case where a gray scale level is 0, no light is emitted in SF1 to SF10. In the case where a gray scale level is 1, no light is emitted in SF1 to SF 7, SF9 and SF10, and light is emitted in SF8. In the case where a gray scale level is 4, no light is emitted in SF2 to SF10, and light is emitted in SF1. In the case where a gray scale level is 5, no light is emitted in SF2 to SF7, SF9 and SF10 and light is emitted in SF1 and SF8. In the case where a gray scale level is 8, no light is emitted in SF3 to SF10 and light is emitted in SF1 and SF2. Note that SF1 to SF7 are subframes for the high-order bits, and SF8 to SF10 are subframes for the low-order bits.

Subsequently, description is made on a method of displaying each gray scale level, that is, a method of selecting each subframe. When a gray scale level is 0 to 3, no light is emitted in SF1 to SF7 since the overlapping time gray scale method is used for high-order 3 bits. In the case where a gray scale level is 4 to 7, light is emitted in SF1, and no light is emitted in SF2 to SF7. In the case where a gray scale level is 8 to 11, light is emitted in SF1 and SF2, and no light is emitted in SF3 to SF7. In the case where a gray scale level is 12 to 15, light is emitted in SF1 to SF3, and no light is emitted in SF4 to SF7. When a gray scale level is further increased, whether light is emitted or not is selected similarly.

Thus, gray scales are displayed in the high-order 3 bits by sequentially adding a light-emitting period in each subframe. That is, as a gray scale level is increased, light is emitted in more subframes. Therefore, in the case where a gray scale level is 4 or more, light is always emitted in SF1. In the case where a gray scale level is 8 or more, light is always emitted in SF2. In the case where a gray scale level is 12 or more, light is always emitted in SF3. The same applies to SF4 to SF7. That is to say, in a subframe where light is emitted when a gray scale level is low, light is emitted when a gray scale level is high.

By using such a driving method, pseudo contour can be reduced. This is because in a certain gray scale level, light is emitted in all the subframes where light is emitted when a gray scale level is lower than that. Therefore, it can be prevented that an image is displayed with inaccurate luminance in a boundary of gray scale levels even if eyes move.

The overlapping time gray scale method is also used for low-order 2 bits. Therefore, in the case where a gray scale level is 0, 4, 8, 12, 16, . . . , no light is emitted in SF8 to SF10. In the case where a gray scale level is 1, 5, 9, 13, 17, . . . , light is emitted in SF8, and no light is emitted in SF9 and SF10. In the case where a gray scale level is 2, 6, 10, 14, 18, . . . , light is emitted in SF8 and SF9, and no light is emitted in SF10. In the case where a gray scale level is 3, 7, 11, 15, 19, . . . , light is emitted in SF8 to SF10.

Thus, gray scales are displayed in the low-order 2 bits by sequentially adding a light-emitting period in each subframe. That is, as a gray scale level is increased in the range of the low-order bits, light is emitted in more subframes. That is to say, in a subframe where light is emitted when a gray scale level is low in the range of the low-order bits, light is emitted when a gray scale level is high in the range of the low-order bits.

By using such a driving method, pseudo contour can be reduced. This is because in the range of the low-order bits when light is emitted in a certain subframe in a certain grayscale level, light is always emitted in the subframe in a higher gray scale level than the certain gray scale level. Therefore, it can be prevented that an image is displayed with inaccurate luminance in a boundary of gray scale levels even if eyes move.

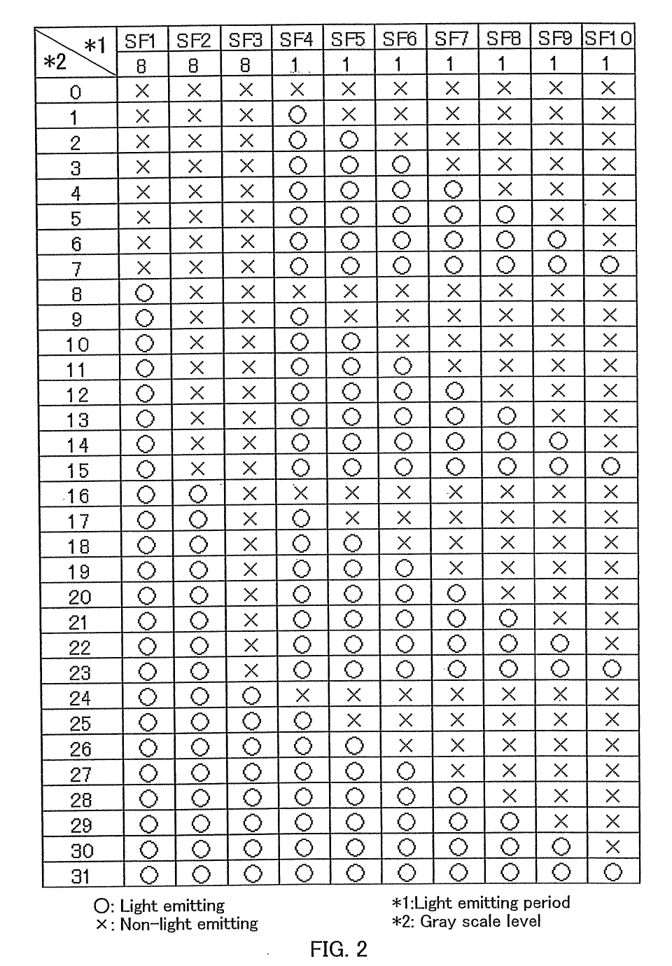

Thus, FIG. 1 shows a method of selecting a subframe in the case where the high-order bits are 3 bits and the low-order bits are 2 bits. Next, a method of selecting a subframe in the case where the high-order bits are 2 bits and the low-order bits are 3 bits is shown in FIG. 2.

The high-order 2 bits are displayed using 3 subframes (SF1 to SF3), thereby 2-bit gray scale, that is, 4 gray scales can be displayed. The low-order 3 bits are displayed using 7 subframes (SF4 to SF10), thereby 3-bit gray scale, that is, 8 gray scales can be displayed. Thus, 5-bit gray scale can be displayed by 10 subframes including 3 subframes for the high-order bits and 7 subframes for the low-order bits.

Pseudo contour is often generated when a method of selecting subframes is greatly changed in terms of a time or a place. Therefore, in the case of FIG. 1, it may be generated when a gray scale level is changed from 3 to 4, from 7 to 8, from 12 to 13, and the like. In the case of FIG. 1, such a change occurs in 7 points. When a method of selecting subframes is greatly changed, a difference of a sum of light emitting periods of subframes at the points is small. Accordingly, the intensity of pseudo contour is low so that it cannot be seen easily.

On the other hand, in the case of FIG. 2, pseudo contour may be generated when a gray scale level is changed from 7 to 8, from 15 to 16, from 23 to 24, and the like. In the case of FIG. 2, such a change occurs in 3 points. It is to be noted that a difference of a sum of light emitting periods is large. Accordingly, the intensity of pseudo contour is high so that it may be seen easily.

Therefore, in the case of FIG. 1, pseudo contour is often generated while the intensity of pseudo contour is low, whereas in the case of FIG. 2, pseudo contour is not often generated while the intensity of pseudo contour is high. In view of the abovementioned, division into high-order bits and low-order bits may be determined.

Note that the length of a light-emitting period in each subframe for the high-order bits is 8, in the case of dividing into the high-order 2 bits and the low-order 3 bits. This is because the low-order bits are 3 bits. Since 3-bit gray scale, that is, 8 gray scales can be displayed, a light-emitting period is required to be increased by at most 8 in the high-order bits. In view of the abovementioned, it is desirable that a length of the light-emitting period in a subframe in the high-order bits is equal to or less than a length of the light-emitting period in the case of the highest gray scale level in the low-order bits. When a length of the light-emitting period in a subframe for the high-order bits is shorter than a length of the light-emitting period in the highest gray scale level of the low-order bits, some of methods of selecting subframes are not used actually in the low-order bits.

Note that the length of a light-emitting period is appropriately changed in accordance with a total number of gray scales (number of bits), a total number of subframes, and the like. Therefore, when a total number of gray scales (number of bits), or a total number of subframes is changed, the length of an actual light-emitting period (for example, μs) may be changed even if the length of the light emitting period is the same.

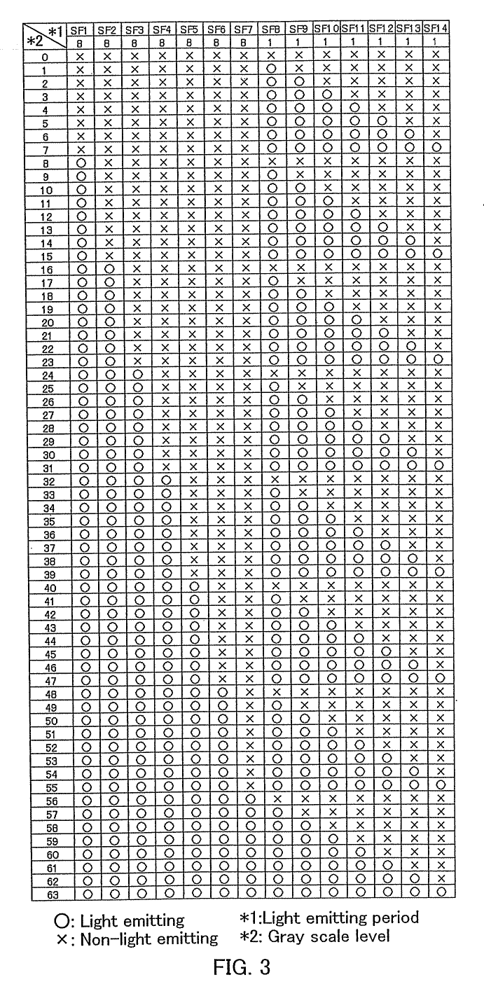

Subsequently, a case of displaying 6-bit gray scale is considered. FIG. 3 shows a method of selecting a subframe in the case where the high-order bits are 3 bits, and the low-order bits are 3 bits.

The high-order 3 bits are displayed using 7 subframes (SF1 to SF7). Accordingly, 3-bit gray scale, that is, 8 gray scales can be displayed. The low-order 3 bits are displayed using 7 subframes (SF 8 to SF 14). Accordingly, 3-bit gray scale, that is, 8 gray scales can be displayed. The length of each light-emitting period in the high-order bits is 8. Thus, 6-bit gray scale can be displayed by 14 subframes including 7 subframes for the high-order bits and 7 subframes for the low-order bits.

Note that in the case of displaying 6-bit gray scale, similarly to FIG. 2, gray scales can also be displayed by arbitrarily dividing into the high-order bits and the low-order bits and using the overlapping time gray scale method.

Although description is thus made on the cases where 5-bit or 6-bit gray scale is displayed in FIGS. 1 to 3, various numbers of bits may be adopted similarly. That is, in the case where n-bit gray scale is displayed, and the high-order bits are a bits while the low-order bits are b bits, the number of subframes in the high-order bits is at least (2a−1), and the number of subframes in the low-order bits is at least (2b−1). The length of a light-emitting period in a subframe for the high-order bits is 2b.

Thus, by dividing gray scales into a plurality of regions and using the overlapping time gray scale method in each of the regions, images can be displayed with reduced pseudo contour and a large number of gray scales without increasing the number of subframes.

Note that when one gray scale level is displayed, a plurality of combinations of subframes may be adopted in some cases. Therefore, the combination of subframes in a certain gray scale level may be changed in accordance with time or place. In addition, the combination may be changed in accordance with both time and place.

For example, when a certain gray scale level is displayed, a method of selecting a subframe may be changed between an odd-numbered frame and an even-numbered frame. Further, when a certain gray scale level is displayed, a method of selecting a subframe may be changed between a pixel in an odd-numbered row and a pixel in an even-numbered row. Furthermore, when a certain gray scale level is displayed, a method of selecting a subframe may be changed between a pixel in an odd-numbered column and a pixel in an even-numbered column.

Note that although the above description is made on the case where gray scales are displayed by the overlapping time gray scale method, another gray scale method may be additionally used. For example, an area gray scale method may be additionally used, where gray scales is displayed by dividing one pixel into a plurality of sub pixels and changing an area in which light is emitted. As a result, pseudo contour can be further reduced.

The above description is made on the case where light-emitting period is increased in linear proportion to a gray scale level. Subsequently, description is made on a case where a gamma correction is performed. The gamma correction is performed so that a light-emitting period is increased nonlinearly as a gray scale level is increased. Even when luminance is increased in linear proportion, human eyes cannot sense that luminance is increased in linear proportion. As luminance is increased, the difference of brightness is less visible to human eyes. Therefore, in order that the difference of brightness is visible to human eyes, it is required that a light-emitting period is increased as a gray scale level is increased, that is, a gamma correction is performed.

As the simplest method, a larger number of bits (gray scale levels) are prepared than the number of bits actually required to be displayed. For example, when 6-bit gray scale (64 gray scales) is actually displayed, 8-bit gray scale (256 gray scales) is prepared to be displayed. In actually performing the display, 6-bit gray scale (64 gray scales) is displayed so that the luminance of a gray scale level has a non-linear shape. Accordingly, a gamma correction can be realized.

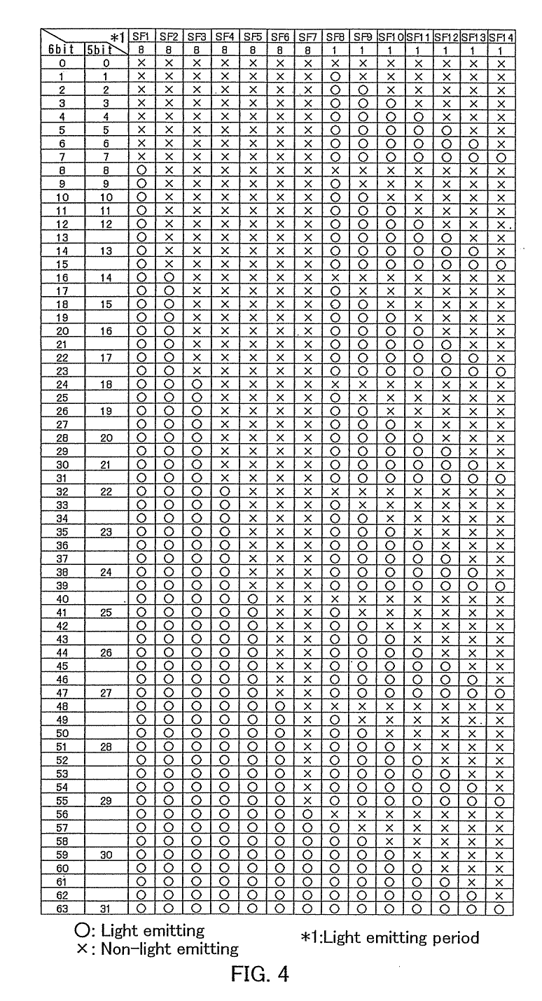

As an example, FIG. 4 shows a method of selecting a subframe in the case where 6 bits is prepared to be displayed although 5-bit gray scale is actually displayed by performing a gamma correction. In FIG. 4, gray scale levels of 0 to 12 in 5-bit gray scale are the same as those in 6-bit gray scale. However, as for a gray scale level of 13 in 5-bit gray scale, to which a gamma correction is performed, light is emitted using a method of selecting subframes in the case of a gray scale level of 14 in 6-bit gray scale. Similarly, as for a gray scale level of 14 in 5-bit gray scale, to which a gamma correction is performed, a gray scale level of 16 in 6-bit gray scale is actually displayed. As for a gray scale level of 15 in 5-bit gray scale, to which a gamma correction is performed, a gray scale level of 18 in 6-bit gray scale is actually displayed. Thus, display may be performed in accordance with a table in which gray scale levels in 5-bit gray scale, to which a gamma correction is performed, are related to gray scale levels in 6-bit gray scale. In this manner, a gamma correction can be realized.

Note that the table in which gray scale levels in 5-bit gray scale, to which a gamma correction is performed, are related to gray scale levels in 6-bit gray scale can be changed appropriately, thereby the level of a gamma correction can easily be changed.

Further, the number of bits (e.g., q bits, q is an integer) to be displayed after a gamma correction and the number of bits (e.g., p bits, p is an integer) using for a gamma correction are not limited to these. In the case where display is performed after a gamma correction, it is desirable that the number of bits p is set as large as possible. It is to be noted that too large number of bits p may adversely affect such that the number of subframes is too large. Therefore, a relation between the number of bits p and the number of bits q is desirably set to q+2=p=q+5. As a result, gray scales can be displayed smoothly without increasing the number of subframes too much.

As another method of performing a gamma correction, length of light-emitting periods in subframes for high-order bits are made different in the case where the overlapping time gray scale method is used.

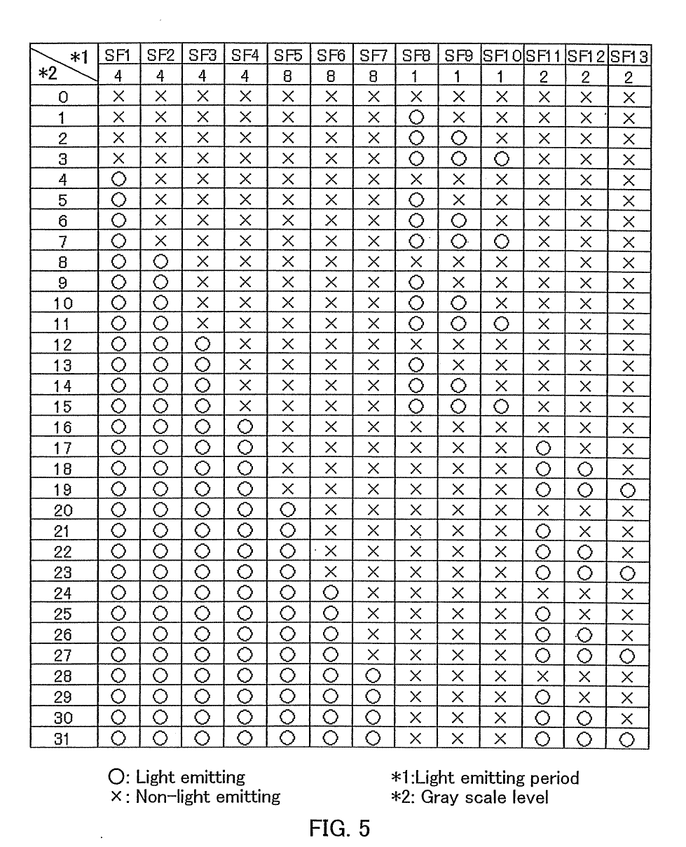

As an example, FIG. 5 shows a method of selecting a subframe in the case where gray scale levels of 0 to 15 are normally displayed, and the length of each of the light-emitting periods of gray scale levels of 16 to 31 is twice as long as the normal length of a light-emitting period. This case is different from FIG. 1 in that each of the light-emitting periods of subframes 5 (SF 5) to 7 (SF7) that correspond to subframes for higher-order bits among subframes for the high-order bits used for the overlapping time gray scale method is twice as long as that of FIG. 1, and each of the light-emitting periods of subframes added for the low-order bit is twice as long as that of FIG. 1.

In the gray scale levels of 0 to 15, subframes SF8 to SF10 are used for the low-order bits. On the other hand, in the gray scale levels of 16 to 31, subframes SF11 to SF13 are used for the low-order bits. Thus, the length of a light-emitting period is changed smoothly as a gray scale level is increased.

In this manner, pseudo contour can be reduced.

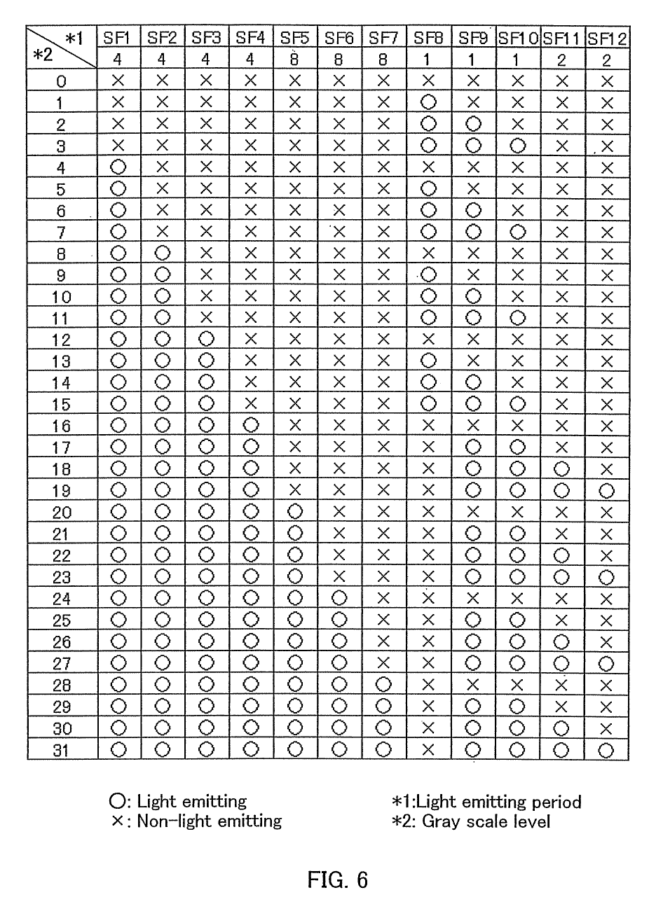

Note that in the gray scale levels of 16 to 31, a subframe other than SF11 to SF13 may be used as a subframe used for the low-order bit. According to this, the number of subframes can be reduced. FIG. 6 shows an example where the number of subframes is reduced by using SF9 and SF10 instead of SF11 in FIG. 5.

Note that, although a length of a light-emitting period in a subframe used for the high-order bit is twice as long as a length of a light-emitting period in the other subframes used for the high-order bit in FIGS. 5 and 6, the invention is not limited to this. A length of a light-emitting period may be controlled in accordance with a gamma value which is used when a gamma correction is performed. That is, a length of a light-emitting period in a subframe used for the high-order bits may be changed and longer than a length of a light-emitting period in the other subframes used for the high-order bits.

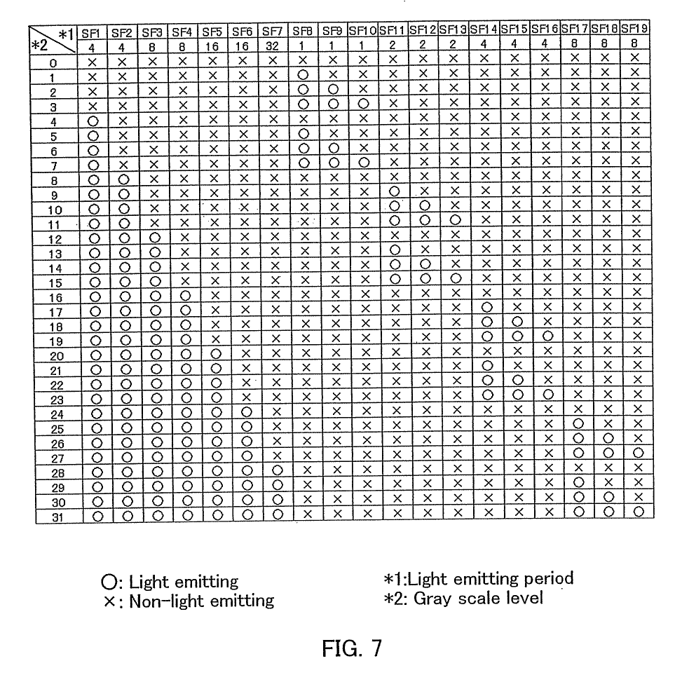

Note that although gray scale levels are divided into two parts in FIGS. 5 and 6, the invention is not limited to this. The gray scale levels may be divided into more parts. As an example, FIG. 7 shows a case where the gray scale levels are divided into four parts.

First, gray scale levels are divided into gray scale levels of 0 to 7, gray scale levels 8 to 15, gray scale levels of 16 to 23, and gray scale levels of 24 to 31. A length of each of the light-emitting periods between the gray scale level of 0 and the gray scale level of 7 is changed normally. A variation of the length of each of the light-emitting periods in the gray scale levels of 8 to 15 is twice as long as a variation in gray scale levels of 0 to 7, the length of each of the light-emitting periods in the gray scale levels of 16 to 23 is four times as long as a variation in gray scale levels of 0 to 7, and the length of each of the light-emitting periods in the gray scale levels of 24 to 31 is eight times as long as a variation in gray scale levels of 0 to 7. In this case, the length of a light-emitting period is doubled sequentially in a subframe for a higher-order bit among subframes for high-order used for the overlapping time gray scale method. Further, a subframe is added for the low-order bits, and the length of a light-emitting period in the added subframe is also doubled sequentially.

In the case where a gray scale level is 0 to 7, subframes SF8 to SF10 are used for the low-order bits. In the case where a gray scale level is 8 to 15, subframes SF11 to SF13 are used for the low-order bits. In the case where a gray scale level is 16 to 23, subframes SF14 to SF16 are used for the low-order bits. In the case where a gray scale level is 24 to 31, subframes SF17 to SF19 are used for the low-order bits. Thus, the length of a light-emitting period is changed smoothly as a gray scale level is increased.

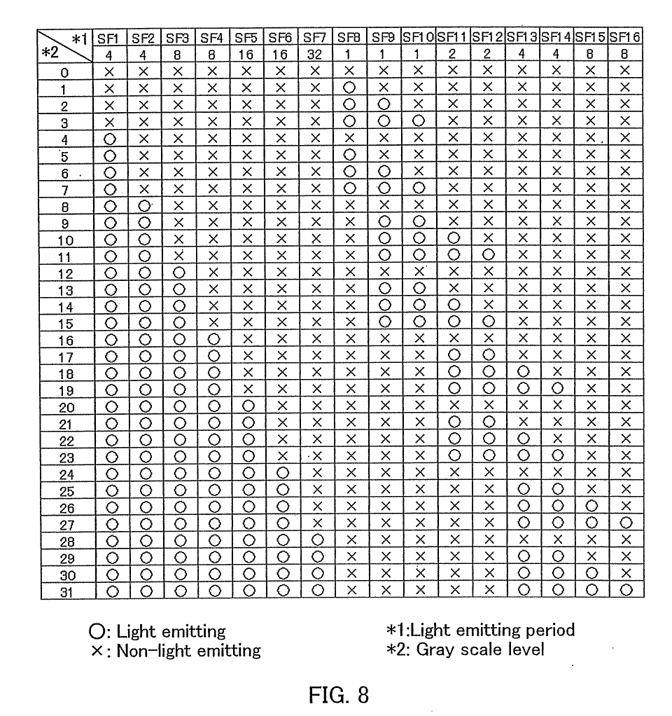

Note that subframes used for the low-order bits are not necessarily divided in accordance with each of the divided gray scale levels. Accordingly, the number of subframes can be reduced. FIG. 8 shows an example in which the number of subframes is reduced by using SF9 and SF10 instead of SF11 in FIG. 7, using SF12 and SF13 instead of SF14, and using SF15 and SF16 instead of SF17.

Note that although the length of a light-emitting period is doubled in each of the regions of gray scales, the present invention is not limited to this. The length may be increased by a power of 2, for example, by 4 times or 8 times. Alternatively, the length of a light-emitting period may be increased little by little. The length of a light-emitting period may be controlled in accordance with the gamma value which is used when a gamma correction is performed. That is, a length of a light-emitting period in a subframe used for the overlapping time gray scale method may be changed and longer than a length of a light-emitting period in the other subframes.

The above description is made on the method of displaying gray scales, that is, the method of selecting a subframe. Subsequently, description is made on the order that a subframe appears.

Although a case of FIG. 1 is used here as an example, the present invention is not limited to this and can be applied to the other figures.

First, as the most basic structure, one frame is constituted by SF8, SF9, SF10, SF1, SF2, SF3, SF4, SF5, SF6, and SF7 in this order A subframe having the shortest light-emitting period is provided first, followed by subframes arranged according to the order of light emitting in the overlapping time gray scale method.

Alternatively, one frame may be constituted by SF7, SF6, SF5, SF4, SF3, SF2, SF1, SF10, SF9, and SF8 as a reversed order. Subframes for the high-order bits and subframes for the low-order bits may appear in opposite order. For example, one frame may be constituted by SF1, SF2, SF3, SF4, SF5, SF6, SF7, SF8, SF9, and SF10 in this order.

Subsequently, a subframe for the low-order bits is provided between any of subframes for the high-order bits. For example, the order is such that SF1, SF8, SF2, SF9, SF3, SF10 SF4, SF5, SF6, and SF7. That is, SF8, SF9, and SF10 that are subframes for the low-order bits are provided between SF1 and SF2, between SF2 and SF3, and between SF3 and SF4, respectively. Note that a position and the number of a subframe for the low-order bits which is provided between subframes for the high-order bits are not limited thereto. Further, the number of subframes that is sandwiched is not limited to this.

Thus, by providing a subframe for the low-order bits between subframes for the high-order bits, pseudo contour is less visible because of trick of eyesight.

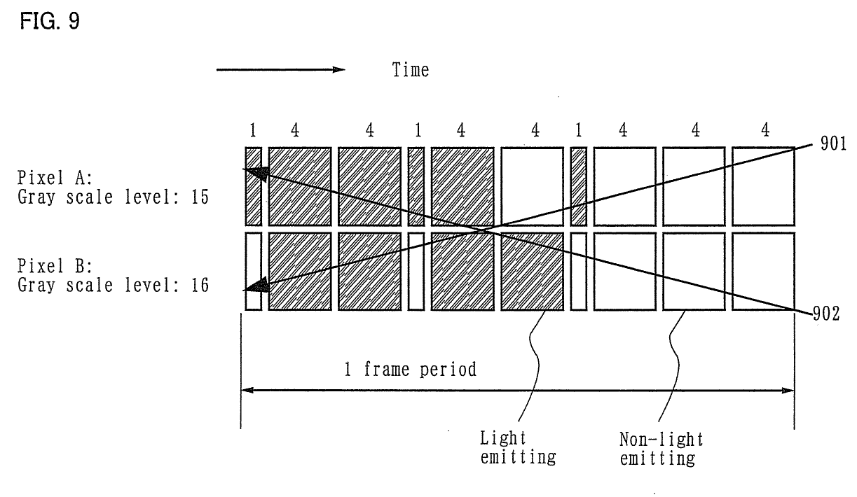

FIG. 9 shows the case where 5-bit gray scale is displayed using SF8, SF1, SF2, SF9, SF3, SF4, SF10, SF5, SF6, and SF7 arranged in this order. A gray scale level of 15 is displayed in the pixel A, and a gray scale level of 16 is displayed in the pixel B. Here, in the case where eyes move, a gray scale level of 18 (=1+4+4+1+4+4) is visible along a line of sight 902, and a gray scale level of 13 (=4+4+4+1) is visible along a line of sight 901. Although gray scale levels of 15 and 16 should be visible, gray scale levels of 18 to 13 are actually visible. Therefore, a gap between gray scales is small so that pseudo contour is reduced.

Note that subframes for the high-order bits may be arranged in the order in which light is emitted (for example, SF1, SF2, SF3, SF4, SF5, SF6, and SF7), or in the reversed order (for example, SF7, SF6, SF5, SF4, SF3, SF2, and SF1). Alternatively, light emission may be started from a middle subframe (SF7, SF5, SF1, SF3, SF2, SF4, and SF6). Accordingly, pseudo contour is reduced in a boundary between a first frame and a second frame. The so-called moving image pseudo contour can be reduced.

Alternatively, subframes may be arranged at random (for example, SF1, SF6, SF2, SF4, SF3, SF5, and SF7), thereby pseudo contour is less visible because of trick of eyesight.

As an example, subframes in one frame appear in the order of SF8, SF1, SF5, SF9, SF2, SF6, SF10, SF4, SF7, and SF3. This case corresponds to the case where subframes for the high-order bits are arranged at random, and subframes for the low-order bits are arranged between subframes for the high-order bits.

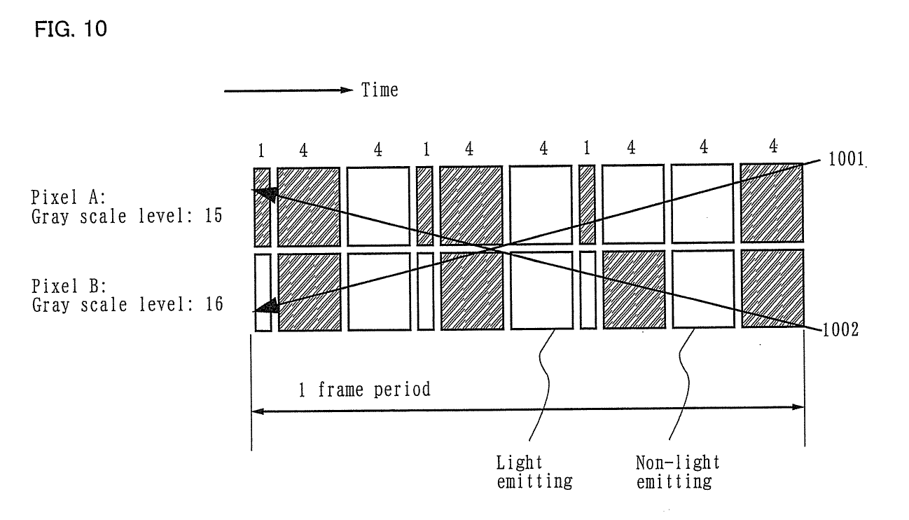

Such a case is shown in FIG. 10. Here, in the case where eyes move, a gray scale level of 18 (=1+4+1+4+4+4) is visible along a line of sight 1002, and a gray scale level of 13 (=4+4+1+4) is visible along a line of sight 1001. Although gray scale levels of 15 and 16 should be visible, gray scale levels of 13 to 18 are actually visible. Therefore, the case of FIG. 9 is not largely different from the case of FIG. 10.

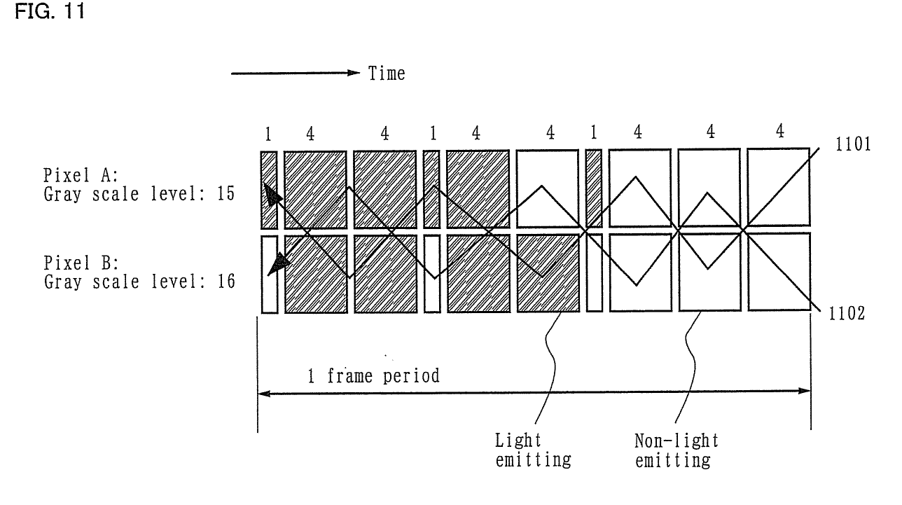

Meanwhile, it is assumed that eyes move rapidly. For example, FIG. 11 shows the case where eyes move rapidly in FIG. 9. When eyes move rapidly, a gray scale level of 19 (=1+4+4+1+4+4+1) is visible along a line of sight 1101, and a gray scale level of 12 (=4+4+4) is visible along a line of sight 1102. Although gray scale levels of 15 and 16 should be visible, gray scale levels of 12 to 19 are actually visible.

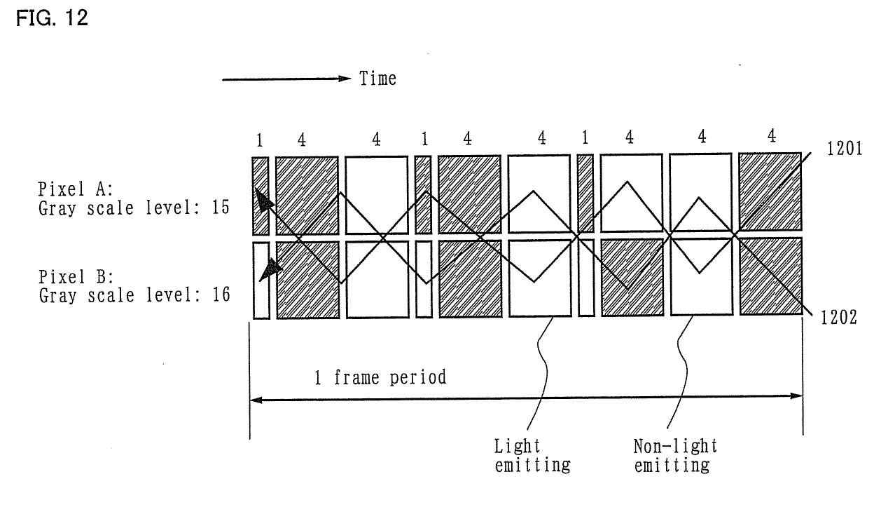

On the other hand, FIG. 12 shows the case where eyes move rapidly in FIG. 10. When eyes move rapidly, a gray scale level of 15 (=1+4+1+4+1+4) is visible along a line of sight 1201, and a gray scale level of 16 (=4+4+4+4) is visible along a line of sight 1202. Gray scale levels of 15 and 16 that are to be visible are displayed correctly. Therefore, the case of FIG. 11 is largely different from the case of FIG. 12. That is, subframes arranged by the overlapping time gray scale method are desirably arranged as randomly as possible so that pseudo contour is reduced further.

Thus, the order in which subframes appear may be determined by determining the order of subframes for the high-order bits and providing subframes for the low-order bits between the subframes for the high-order bits.

At this time, subframes for the low-order bits may be arranged in order from a subframe having the shortest light-emitting period (for example, SF8, SF9, and SF10), or in the reversed order (for example, SF10, SF9, and SF8). Alternatively, light emission may be started from a middle subframe. Alternatively, subframes for the low-order bits may be arranged at random. Accordingly, pseudo contour is reduced because of trick of eyesight.

Further, in the case where subframes for the low-order bits are provided between subframes for the high-order bits, the number of the subframes for the low-order bits is not particularly limited.

Further, the order in which subframes appear may be determined by determining the order of subframes for the low-order bits and providing subframes for the high-order bits between the subframes for the low-order bits.

Thus, subframes for the low-order bits are arranged between subframes for the high-order bits so as not to be concentrated at one portion. Consequently, pseudo contour can be reduced because of trick of eyesight.

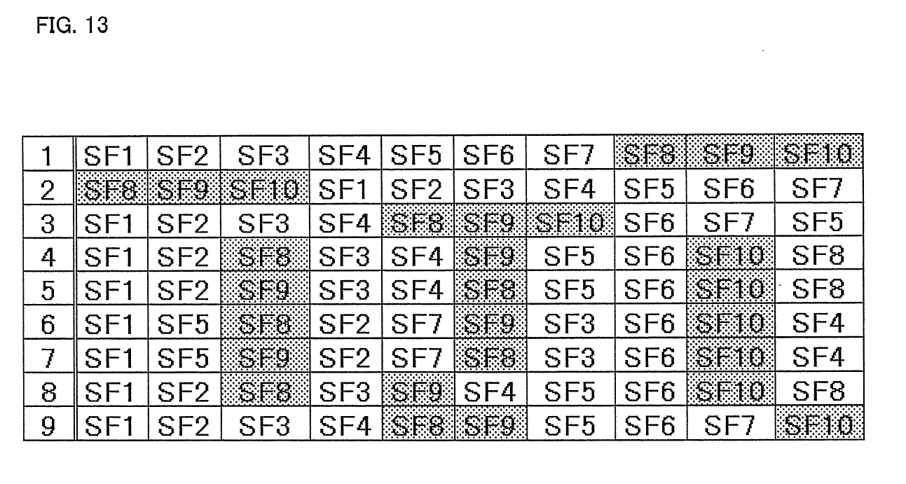

FIG. 13 shows an example of patterns of the order in which subframes appear in FIG. 1.

As a first pattern, the order is such that SF1, SF2, SF3, SF4, SF5, SF6, SF7, SF8, SF9 and SF10. Subframes for the low-order bits are arranged together at the end of one frame.

As a second pattern, subframes appear in the order of SF8, SF9, SF10, SF1, SF2, SF3, SF4, SF5, SF6, and SF7. Subframes for the low-order bits are arranged together at the first of one frame.

As a third pattern, subframes appear in the order is of SF1, SF2, SF3, SF4, SF8, SF9, SF10, SF6, SF7, and SF5. Subframes for the low-order bits are arranged together in the middle of one frame.

As a fourth pattern, subframes appear in the order of SF1, SF2, SF8, SF3, SF4, SF9, SF5, SF6, SF10, and SF7. Subframes for the high-order bits are arranged in order. Subframes for the low-order bits are also arranged in order. After two subframes for the high-order bits, one subframe for the low-order bits is arranged.

As a fifth pattern, subframes appear in the order of SF, SF2, SF9, SF3, SF4, SF8, SF5, SF6, SF10, and SF7. This pattern corresponds to the fourth pattern, where the subframes for the low-order bits are arranged at random.

As a sixth pattern, subframes appear in the order of SF1, SF5, SF8, SF2, SF7, SF9, SF3, SF6, SF10, and SF4. This pattern corresponds to the fourth pattern, where the subframes for the high-order bits are arranged at random.

As a seventh pattern, subframes appear in the order of SF1, SF5, SF9, SF2, SF7, SF8, SF3, SF6, SF10, and SF4. This pattern corresponds to the fourth pattern, where the subframes for the high-order bits are arranged at random, and the subframes for the low-order bits are arranged at random.

As an eighth pattern, subframes appear in the order of SF1, SF2, SF8, SF3, SF9, SF4, SF5, SF6, SF10, and SF7. In this pattern, two subframes for the high-order bits, one subframe for the low-order bits, one subframe for the high-order bits, one subframe for the low-order bits, three subframes for the high-order bits, one subframe for the low-order bits, and one subframe for the high-order bits are arranged in this order.

As a ninth pattern, subframes appear in the order of SF, SF2, SF3, SF4, SF8, SF9, SF5, SF6, SF7, and SF10. In this pattern, four subframes for the high-order bits, two subframes for the low-order bits, three subframes for the high-order bits, and one subframe for the low-order bits are arranged in this order.

Thus, it is desirable that light is emitted in one of a plurality of subframes corresponding to the high-order bits, one of one or more subframes corresponding to the low-order bits, and then another one of the plurality of subframes corresponding to the high-order bits.

Further, it is desirable that light is emitted in one of a plurality of subframes corresponding to the low-order bit, one of a plurality of subframes corresponding to the high-order bits, and then another one of the plurality of subframes corresponding to the low-order bits.

Further, it is desirable that light is emitted in one of a plurality of subframes corresponding to the low-order bits, some of a plurality of subframes corresponding to the high-order bits, and then another one of the plurality of subframes corresponding to the low-order bits.

Further, it is desirable that light is emitted in one of a plurality of subframes corresponding to the high-order bits, some of a plurality of subframes corresponding to the low-order bits, and then another one of the plurality of subframes corresponding to the high-order bits.

Note that the order in which subframes appear may be changed in accordance with time. For example, the order in which subframes appear may be changed between a first frame and a second frame. Further, the order in which subframes appear may be changed by place. For example, the order in which subframes appear may be changed between the pixel A and the pixel B. Further, the order in which subframes appear may be changed by time and place by combining these.

Note that although a frame frequency of 60 Hz is generally used, the present invention is not limited to this. Pseudo contour may be reduced by increasing a frame frequency. For example, a display device may be operated at 120 Hz that is twice as high as the normal the frequency.

### Embodiment Mode 2

In this embodiment mode, description is made on an example of a timing chart. Although the method of FIG. 1 is used for selecting a subframe as an example, the present invention is not limited to this. The present invention can easily be applied to the other methods of selecting a subframe, the other numbers of gray scale levels, and the like.

Further, although the order in which subframes appear is SF1, SF8, SF2, SF9, SF3, SF10, SF4, SF5, FS6, and SF7 as an example, the present invention is not limited to this and can easily be applied to other orders.

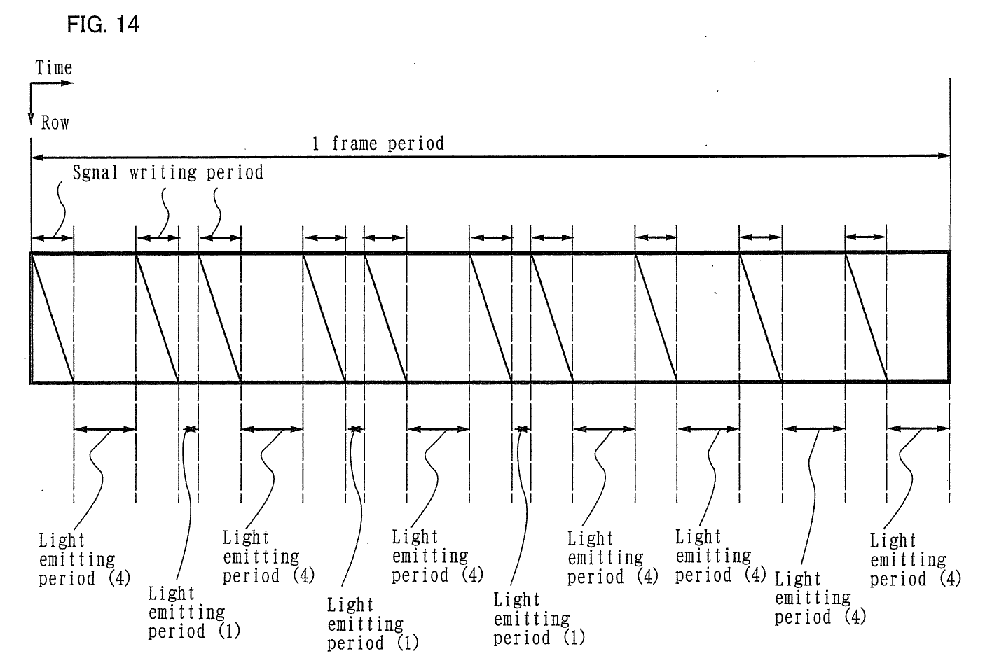

FIG. 14 shows a timing chart in the case where a period in which signals are written to a pixel and a period in which light is emitted are separated. First, signals for one screen are inputted to all pixels in a signal writing period. During the signal writing period, the pixels do not emit light. After the signal writing period finishes, a light-emitting period begins and a pixel emits light. A length of the light-emitting period at this time is 4. Next, subsequent subframe begins and a signal for one screen are inputted to all pixels in a signal writing period. During the signal writing period, the pixels do not emit light. After the signal writing period finishes, a light-emitting period begins and a pixel emits light. A length of the light-emitting period at this time is 1.

By repeating similar operations, lengths of the light-emitting periods are arranged in the order of 4, 1, 4, 1, 4, 1, 4, 4, 4, and 4.

A driving method that a period in which a signal is written to a pixel and a period in which light is emitted are separated is thus preferably applied to a plasma display. Note that, in the case where the driving method is used for a plasma display, an operation for initialization and the like are required, which is omitted here for simplicity.

Further, this driving method is also preferably applied to an EL display (an organic EL display, an inorganic EL display, a display including an element containing both an organic material and an inorganic material, or the like), a field emission display, a display using a digital micromirror device (DMD), and the like.

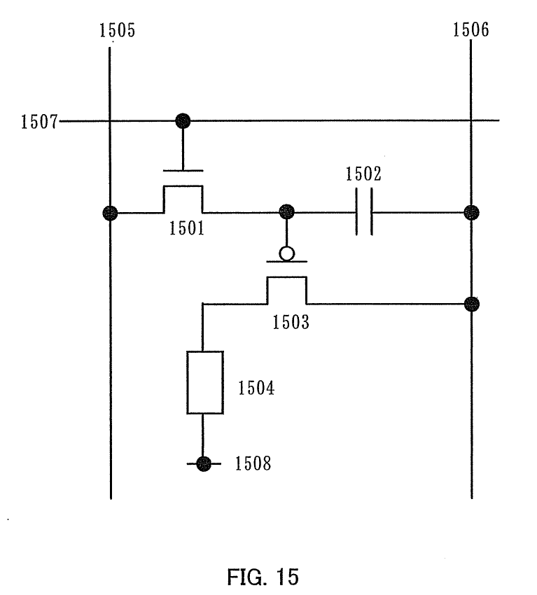

FIG. 15 shows a pixel configuration in the case. A gate line 1507 is selected to turn a transistor for selecting 1501 on, and then a signal is inputted from a signal line 1505 to a capacitor 1502. Accordingly, a current flowing through a driving transistor 1503 is controlled in accordance with the signals, and a current flows from a first power source line 1506 to a second power source line 1508 through a display element 1504.

Note that, in a signal writing period, potentials of the first power source line 1506 and the second power source line 1508 are controlled so that a voltage is not applied to the display element 1504. Consequently, the display element 1504 can be prevented from emitting light in the signal writing period.

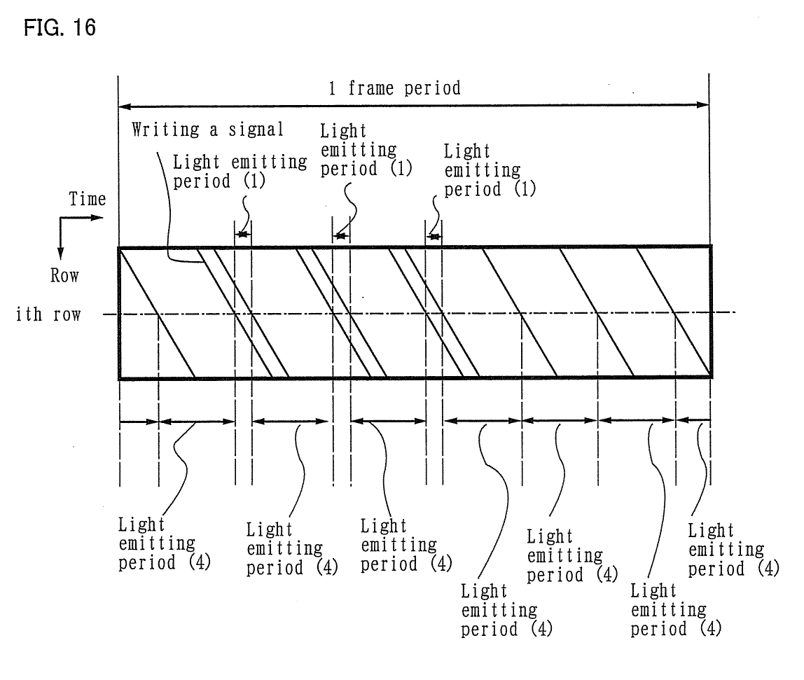

Subsequently, FIG. 16 shows a timing chart in the case where a period in which a signal is written to a pixel and a period in which light is emitted are not separated. Soon after a signal is written to each row, a light-emitting period begins.

In a certain row, a signal is written and a predetermined light-emitting period finishes, and signal starts to be written in a subsequent subframe. By repeating the above-mentioned operations, lengths of light-emitting periods are arranged in the order of 4, 1, 4, 1, 4, 1, 4, 4, 4, and 4.

Accordingly, many subframes can be arranged in one frame even if signals are written slowly.

Such a driving method is preferably applied to a plasma display. Note that, in the case where the driving method is used for a plasma display, an operation for initialization is required, which is omitted here for simplicity.

Further, this driving method is also preferably applied to an EL display, a field emission display, a display using a digital micromirror device (DMD), and the like.

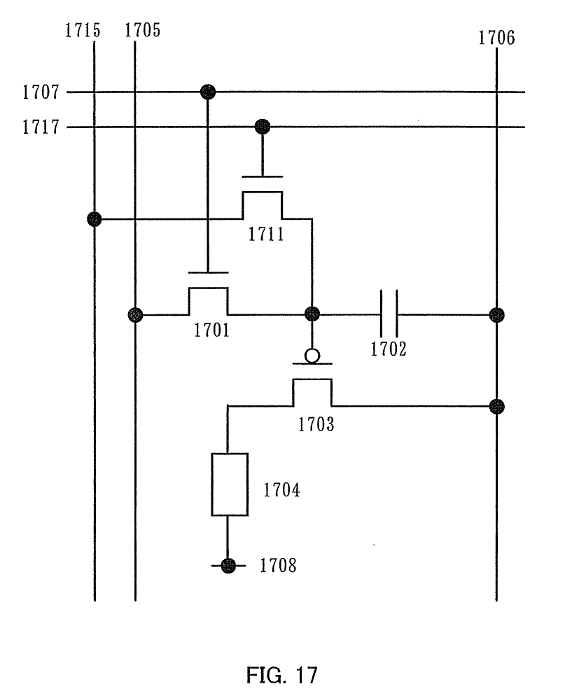

FIG. 17 shows a pixel configuration in the case. A first gate line 1707 is selected to turn a first select transistor 1701 on, and then a signal is inputted from a signal line 1705 to a capacitor 1702. Accordingly, a current flowing through a driving transistor 1703 is controlled in accordance with the signal, and a current flows from a first power source line 1706 to a second power source line 1708 through a display element 1704. Similarly, a second gate line 1717 is selected to turn a second select transistor 1711 on, and then a signal is inputted from a second signal line 1715 to the capacitor 1702. Accordingly, a current flowing through the driving transistor 1703 is controlled in accordance with the signal, and a current flows from the first power source line 1706 to the second power source line 1708 through the display element 1704.

The first gate line 1707 and the second gate line 1717 can be controlled separately. Similarly, the first signal line 1705 and the second signal line 1715 can be controlled separately. Therefore, signals can be inputted to pixels in two rows so that such a driving method as shown in FIG. 16 can be realized.

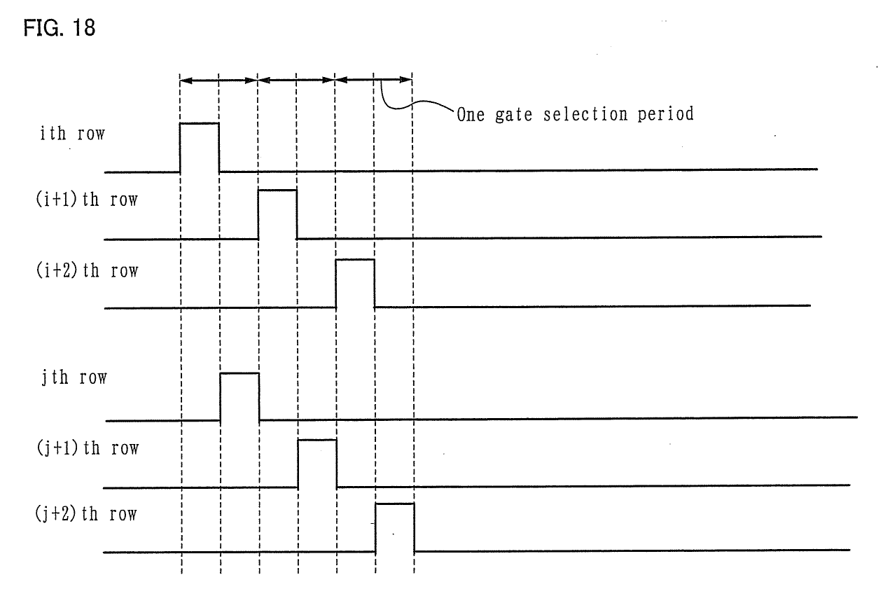

Note that the driving method shown in FIG. 16 can also be realized by using a circuit of FIG. 15. FIG. 18 shows a timing chart of this case. As shown in FIG. 18, one gate selection period is divided into a plurality of periods (two in FIG. 18). Each of gate lines is selected in each of the divided selection periods and each corresponding signal is inputted to the first signal line 1705. For example, in a certain one gate selection period, i-th row is selected in the first half of the period and j-th row is selected in the latter half of the period. Accordingly, an operation can be carried out as if two rows are selected at once in one gate selection period.

Note that details of such a driving method are disclosed in Japanese Patent Laid-Open No. 2001-324958 and the like, of which the details can be applied in combination with the present invention.

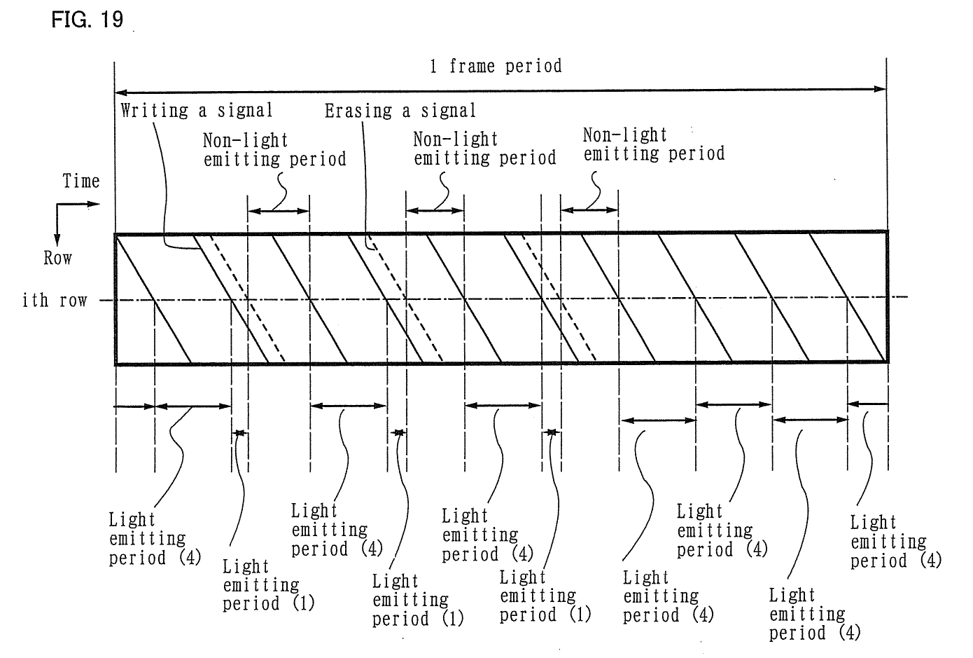

Subsequently, FIG. 19 shows a timing chart in the case where signals in a pixel are erased. A signal is written to each row, and the signal in a pixel is erased before a subsequent operation for writing a signal is carried out. Accordingly, the length of a light-emitting period can easily be controlled.

In a certain row, after a signal is written and a predetermined light-emitting period finishes, a signal starts to be written to a subsequent subframe. In the case where a light-emitting period is short, an operation for erasing a signal is carried out to provide a no light-emitting state. By repeating the abovementioned operations, lengths of light-emitting periods are arranged in the order of 4, 1, 4, 1, 4, 1, 4, 4, 4, and 4.

Note that, although an operation for erasing a signal is carried out in the case where a light-emitting period is 1 and 2 in FIG. 19, the present invention is not limited to this. The operation for erasing a signal may be carried out in the other light-emitting periods.

Accordingly, many subframes can be arranged in one frame even if signals are written slowly. Further, in the case where an operation for erasing signals is carried out, data for erasing is not required to be obtained as well as a video signal so that a frequency of driving a source driver can also be decreased.

Such a driving method is preferably applied to a plasma display. Note that, in the case where the driving method is used for a plasma display, an operation for initialization is required, which is omitted here for simplicity.

Further, this driving method is also preferably applied to an EL display, a field emission display, a display using a digital micromirror device (DMD), and the like.

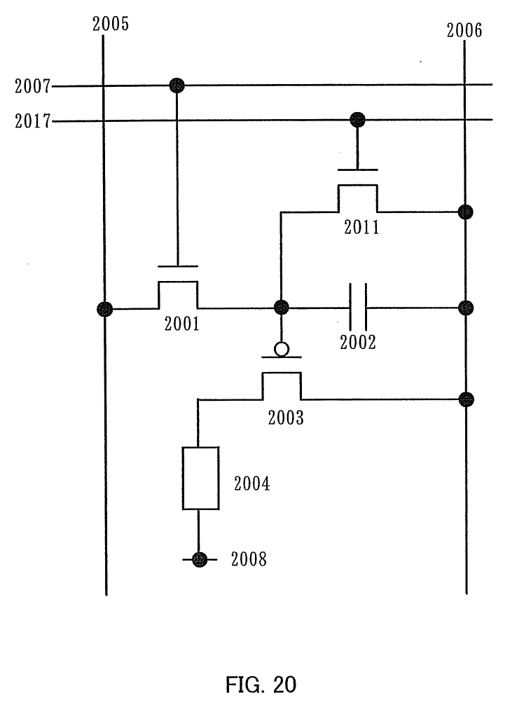

FIG. 20 shows a pixel configuration in the case. A first gate line 2007 is selected to turn a select transistor 2001 on, and then a signal is inputted from a signal line 2005 to a capacitor 2002. Accordingly, a current flowing through a driving transistor 2003 is controlled in accordance with the signal, and current flows from a first power source line 2006 to a second power source line 2008 through a display element 2004.

In the case where a signal is required to be erased, a second gate line 2017 is selected to turn an erase transistor 2011 on and turn the driving transistor 2003 off. Accordingly, a current does not flow from the first power source line 2006 to the second power source line 2008 through the display element 2004. Consequently, a no light-emitting period can be provided so that a length of a light-emitting period can freely be controlled.

Although the erase transistor 2011 is used in FIG. 20, another method can also be used. This is because a no light-emitting period may forcibly be provided so that a current is not supplied to the display element 2004. Therefore, a no light-emitting period may be provided by arranging a switch somewhere in a path where a current flows from the first power source line 2006 to the second power source line 2008 through the display element 2004 and controlling the switch to be turned on/off. Alternatively, a gate-source voltage of the driving transistor 2003 may be controlled to forcibly turn a driving transistor off.

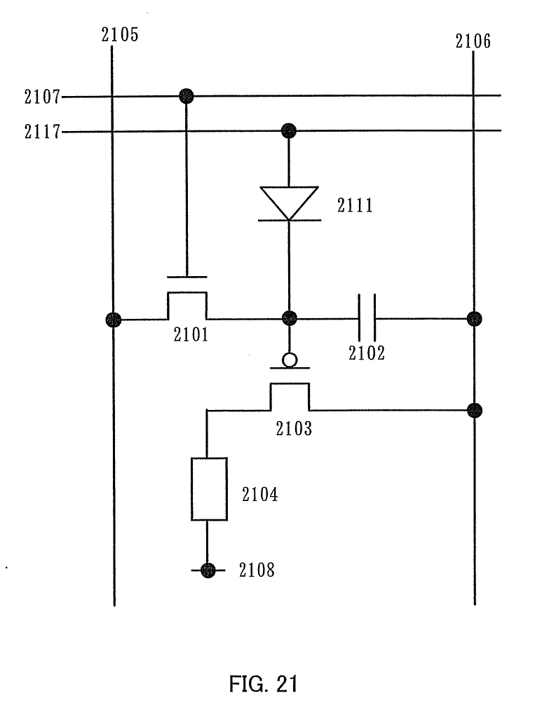

FIG. 21 shows an example of a pixel configuration in the case where a driving transistor is forcibly turned off. A select transistor 2101, a driving transistor 2103, an erase diode 2111, and a display element 2104 are arranged in the pixel configuration. A source and a drain of the select transistor 2101 are connected to a signal line 2105 and a gate of the driving transistor 2103 respectively. A gate of the select transistor 2101 is connected to a first gate line 2107. A source and a drain of the driving transistor 2103 are connected to a power source line 2106 and the display element 2104 respectively. The erase diode 2111 is connected to the gate of the driving transistor 2103 and a second gate line 2117.

A capacitor 2102 plays a role of storing a gate potential of the driving transistor 2103. Therefore, the capacitor 2102 is connected between the gate of the driving transistor 2103 and the power source line 2106, however, the invention is not limited to this. It may be arranged so as to store the gate potential of the driving transistor 2103. Further, in the case where the gate potential of the driving transistor 2103 can be stored by using a gate capacitance of the driving transistor 2103 and the like, the capacitor 2102 may be omitted.

As a method for an operation, the first gate line 2107 is selected to turn the select transistor 2101 on, and then a signal is inputted from the signal line 2105 to the capacitor 2102. Accordingly, a current flowing through the driving transistor 2103 is controlled in accordance with the signal, and current flows from the first power source line 2106 to the second power source line 2108 through the display element 2104.

In the case where a signal is required to be erased, the second gate line 2117 is selected (here, a high potential is provided) to turn the erase diode 2111 on so that a current flows from the second gate line 2117 to the gate of the driving transistor 2103. As a result, the driving transistor 2103 is turned off. Then a current does not flow from the first power source line 2106 to the second power source line 2108 through the display element 2104. Consequently, a no light-emitting period can be provided so that the length of a light-emitting period can freely be controlled.

In the case where a signal is required to be stored, the second gate line 2117 is not selected (here, a low potential is provided). Accordingly, the erase diode 2111 is turned off so that the gate potential of the driving transistor 2103 is stored.

Note that the erase diode 2111 may be anything as far as it is an element having a rectifying property. It may be a PN diode, a PIN diode, a Schottky diode, or a zener diode.

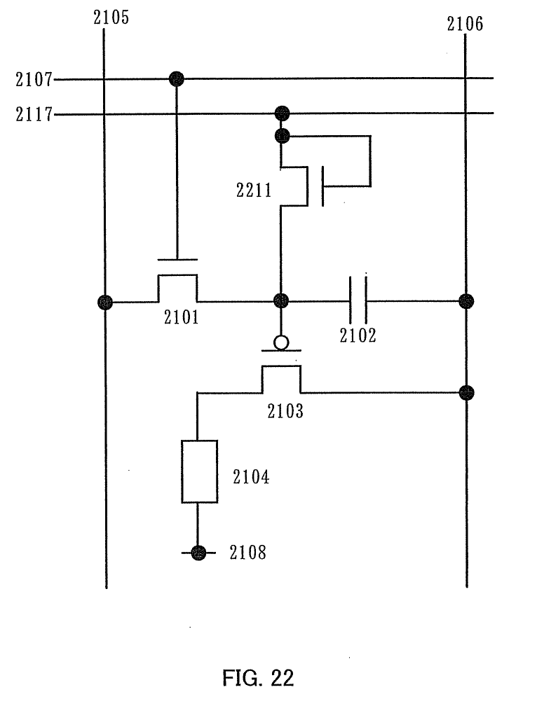

Further the erase diode 2111 may be a diode-connected transistor (a gate and a drain thereof are connected). FIG. 22 shows a configuration in that case. As the erase diode 2111, a diode connected transistor 2211 is used. Although an N-channel type transistor is used here, the present invention is not limited to this. A P-channel type transistor may also be used.

Note that a driving method shown in FIG. 19 can be realized by using a circuit in FIG. 15 as a yet another circuit. FIG. 18 shows a timing chart of that case. As shown in FIG. 18, one gate selection period is divided into a plurality of periods (two in FIG. 18). Each of the gate lines is selected in each of the divided selection periods and each corresponding signal is inputted to the first signal line 1705. For example, in a certain one gate selection period, i-th row is selected in the first half of the period and j-th row is selected in the latter half of the period. When the i-th row is selected, a corresponding video signal is inputted. Meanwhile, when the j-th row is selected, a signal which turns a driving transistor off is inputted. Accordingly, operations can be carried out as if two rows are selected at once in one gate selection period.

Note that details of such a driving method is disclosed in Japanese Patent Laid-Open No. 2001-324958 and the like, of which details can be applied in combination with the present invention.

Note that timing charts, pixel configurations, and driving methods that are shown in this embodiment mode are examples and the present invention is not limited to this. The present invention can be applied to various timing charts, pixel configurations, and driving methods.

Note that the order in which subframes appear may be changed in accordance with time. For example, the order in which subframes appear may be changed between a first frame and a second frame. Further, the order in which subframes appear may be changed by place. For example, the order in which subframes appear may be changed between the pixel A and the pixel B. Further, the order in which subframes appear may be changed in accordance with both time and place by combining thereof.

Note that, in this embodiment mode, although a light-emitting period, a signal writing period and a no light-emitting period are arranged in one frame period, the present invention is not limited to this and other operation periods may also be arranged. For example, a period in which a voltage applied to a display element is set at opposite polarity to normal polarity, that is, a reverse bias period may be provided. Accordingly, reliability of a display element is improved in some cases.

Note that the details described in this embodiment mode can be implemented by freely combining with the details described in Embodiment Mode 1.

### Embodiment Mode 3

In this embodiment mode, description is made on an example of the number of bits allocated to the high-order bit and the low-order bit in the case where a certain gray scale is displayed.

First, the case where gray scales of 6-bit gray scale (64 gray scales) are displayed is considered. As an example, 4 bits (16 gray scales) are used for the high-order bits displayed using 15 subframes, and low-order 2 bits (4 gray scales) are displayed using at least 3 subframes. Note that the number of subframes may be increased further by division of the high-order bits and the like. Accordingly, 18 subframes are provided in total.

As another example, the high-order 3 bits (8 gray scales) are displayed using 7 subframes, and the low-order 3 bits (8 gray scales) are displayed using at least 7 subframes. Note that the number of subframes may be increased further by division of the high-order bits and the like. Accordingly, 14 subframes are provided in total.

As another example, the high-order 6 gray scales are displayed using 5 subframes, and the low-order 4 bits (16 gray scales) are displayed using at least 15 subframes. The number of subframes may be increased further by division of the high-order bits and the like. Note that although more gray scales than that used actually can be displayed in the low-order bits in this case, that is no problem. The most suitable value of low-order bits may be 11 gray scales. In that case, at least 10 subframes are provided. Accordingly, 15 subframes are provided in total.

As another example, the high-order 2 bits (4 gray scales) are displayed using 3 subframes, and the low-order 4 bits (16 gray scales) are displayed using at least 15 subframes. Note that the number of subframes may be increased further by division of the high-order bits and the like. Accordingly, 18 subframes are provided in total.

Subsequently, a case of displaying gray scales of 8-bit gray scale (256 gray scales) is considered. As an example, the high-order 5 bits (32 gray scales) are displayed using 31 subframes, and the low-order 3 bits (8 gray scales) are displayed using at least 7 subframes. The number of subframes may be increased further by division of the high-order bits and the like. Accordingly, 38 subframes are provided in total.

As another example, the high-order 4 bits (16 gray scales) are displayed using 15 subframes, and the low-order 4 bits (16 gray scales) are displayed using at least 15 subframes. The number of subframes may be increased further by division of the high-order bits and the like. Accordingly, 30 subframes are provided in total.

As another example, the high-order 3 bits (8 gray scales) are displayed using 7 subframes, and the low-order 5 bits (32 gray scales) are displayed using at least 31 subframes. The number of subframes may be increased further by division of the high-order bits and the like. Accordingly, 38 subframes are provided in total.

As another example, the high-order 2 bits (4 gray scales) are displayed using 3 subframes, and the low-order 6 bits (64 gray scales) are displayed using at least 63 subframes. The number of subframes may be increased further by division of the high-order bits and the like. Accordingly, 66 subframes are provided in total.

Thus, when n-bit gray scale is displayed, in general, is considered in general, high-order m bits are displayed using (2^{m}−1) subframes, whereas the low-order p bits are displayed using (2^{P}−1) subframes. The number of subframes may be increased further by division of the high-order bits and the like. Accordingly, at least (2^{m}+2^{P}−2) subframes are required in total.

Note that the description of this embodiment mode can be implemented by freely combining with the description of Embodiment Modes 1 and 2.

### Embodiment Mode 4

In this embodiment mode, description is made on an example of a display device using a driving method of the present invention.

As the most typical display device, a plasma display can be given. A pixel of a plasma display can be only in a light-emitting state or a non-light-emitting state. Accordingly, a time gray scale method is used as one of the means for achieving multi-gray scales. Therefore, the present invention can be applied to such a driving method.

Note that in the case of a plasma display, initialization of a pixel is required as well as writing a signal to a pixel. Therefore, subframes are desirably arranged in order in the portion where the overlapping time gray scale method is used. By thus arranging subframes, the number of times of initialization can be reduced. Consequently, the contrast can be improved.

Therefore, for example, it is desirable that subframes for the low-order bits are arranged together in the first or last of a frame. As an example, in the case of FIG. 1, one frame is constituted by SF1, SF2, SF3, SF4, SF5, SF6, SF7, SF8, SF9, and SF10 in this order. Subframes for the low-order bits are arranged together in the last of a frame. Note that it is desirable that subframes for the low-order bits are also arranged in order. This is because the number of times of initialization can be reduced. That is, subframes used in the overlapping time gray scale method are arranged in order. In the case where light is emitted in a certain subframe, light is emitted also in the former subframe. Therefore, the number of times of initialization can be reduced so that the contrast can be improved.

Note that in the case where reduction of pseudo contour is required to take precedence over improvement of the contrast, pseudo contour can be reduced by disposing a subframe for the low-order bits used in the overlapping time gray scale method between subframes for the high-order bits used in the overlapping time gray scale method.

An EL display, a field emission display, a display using a digital micro mirror device (DMD), a ferroelectric liquid crystal display, a bistable liquid crystal display, and the like are given as examples of display devices other than a plasma display. All of them are display devices to which the time gray scale method can be applied. Pseudo contour can be reduced by applying the present invention to these display devices to which the time gray scale method is applied.

For example, in the case of an EL display, an operation such as initialization of a pixel is not required unlike a plasma display. Therefore, a reduction of contrast which is caused by a light emission lead by such an operation as initialization of a pixel does not occur. Accordingly, the order of subframes can be set arbitrarily. Subframes are desirably arranged randomly so as not to generate pseudo contour.

Therefore, subframes for the high-order bits used in the overlapping time gray scale method may be arranged so that subframes where light is emitted are arranged in series, and subframes for the low-order bits used in the overlapping time gray scale method may be randomly arranged between subframes for the high-order bits used in the overlapping time gray scale method. As a result, subframes for the high-order bits used in the overlapping time gray scale method are arranged together to some degree, thereby pseudo contour is prevented from being generated in a boundary between a first frame and a second frame. That is, moving image pseudo contour can be reduced. Further, subframes for the low-order bits used in the overlapping time gray scale method are randomly arranged so that pseudo contour can be reduced.

Alternatively, subframes for the high-order bits used in the overlapping time gray scale method may be randomly arranged, and subframes for the low-order bits used in the overlapping time gray scale method may also be randomly arranged. As a result, pseudo contour generated by the subframes for the low-order bits used in the overlapping gray scale method is mixed with subframes for the high-order bits used in the overlapping gray scale method so that pseudo contour is further reduced as a whole.

Note that the description of this embodiment mode can be implemented by freely combining with the description of Embodiment Modes 1 to 3.

### Embodiment Mode 5

In this embodiment mode, description is made on a display device, a configurations of a signal line driver circuit, a gate line driver circuit, and the like, and operations thereof.

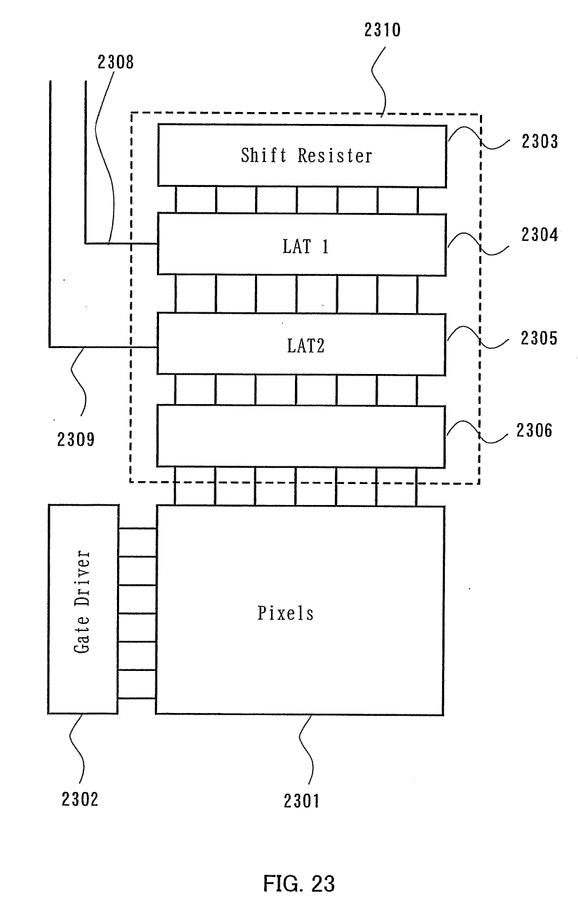

As shown in FIG. 23, a display device includes a pixel portion 2301, a gate line driver circuit 2302, and a signal line driver circuit 2310. The gate line driver circuit 2302 outputs a selection signal sequentially. The gate line driver circuit 2302 includes a shift resister, a buffer circuit, and the like.

Besides, the gate line driver circuit 2302 often includes a level shifter circuit, a pulse width controlling circuit, and the like. The shift resister outputs a pulse that selects a gate line sequentially. The signal line driver circuit 2310 outputs a video signal to the pixel portion 2301 sequentially. The shift resister 2303 outputs a pulse for sampling a video signal. The pixel portion 2301 displays a image by controlling a state of light in accordance with the video signal. The video signal inputted from the signal line driver circuit 2310 to the pixel portion 2301 is often a voltage. That is, states of each display element arranged in each pixel and an element controlling the display element are changed by the video signal (voltage) inputted from the signal line driver circuit 2310. An EL element, an element used for an FED (field emission display), a liquid crystal, a DMD (digital micromirror device), and the like are given as examples of a display element arranged in a pixel.

Note that a plurality of the gate line driver circuits 2302 and the signal line driver circuits 2310 may be arranged.

The signal line driver circuit 2310 is divided into a plurality of portions. Broadly, it can be divided into the shift resister 2303, a first latch circuit (LAT1) 2304, a second latch circuit (LAT2) 2305, and an amplifier circuit 2306. The amplifier circuit 2306 may have a function of converting a digital video signal to an analog signal and a function of performing a gamma correction.

Further, a pixel includes a display element such as an EL element. The display element may be provided with a circuit for outputting a current (video signal), that is, a current source circuit.

Description is briefly made on operations of the signal line driver circuit 2310. A clock signal (S-CLK), a start pulse (SP), and an inverted clock signal (S-CLKb) are inputted to the shift resister 2303, and a sampling pulse is outputted sequentially in accordance with the timing of these signals.

The sampling pulse outputted from the shift resister 2303 is inputted to the first latch circuit (LAT1) 2304. Video signal is inputted from a video signal line 2308 to the first latch circuit (LAT1) 2304, and the video signal is held in each column in accordance with the input timing of the sampling pulse.

After holding of the video signal is completed from the first column to the last column in the first latch circuit (LAT1) 2304, a latch pulse is inputted from a latch control line 2309, and the video signal held in the first latch circuit (LAT1) 2304 is transferred to the second latch circuit (LAT2) 2305 at once in a horizontal retrace period. After that, the video signal of one row, which is held in the second latch circuit (LAT2) 2305, is inputted to the amplifier circuit 2306 at once. A signal to be outputted from the amplifier circuit 2306 is inputted to the pixel portion 2301.

The video signal held in the second latch circuit (LAT2) 2305 is inputted to the amplifier circuit 2306, and the shift resister 2303 outputs a sampling pulse again while the video signal is inputted to the pixel portion 2301. That is, two operations are carried out at once. Accordingly, a line sequential driving is enabled. Hereafter, the aforementioned operations are repeated.

Note that a signal line driver circuit and a portion thereof (such as a current source circuit and an amplifier circuit) may be constituted using an external IC chip instead of being provided over the same substrate as the pixel portion 2301.

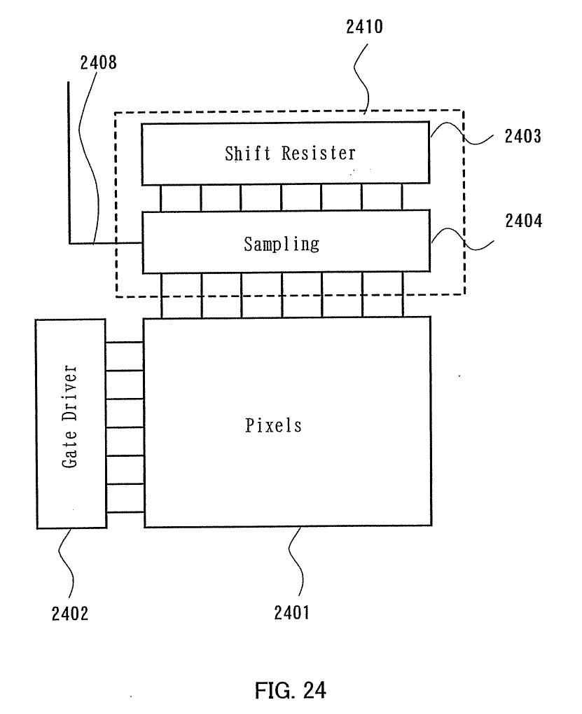

Note that a configuration of a signal line driver circuit, a gate line driver circuit, and the like is not limited to that in FIG. 23. For example, a signal is supplied to a pixel by carrying out a dot sequential driving. FIG. 24 shows an example of a signal line driver circuit 2410 in the case. A sampling pulse is outputted from a shift resister 2403 to a sampling circuit 2404. A video signal is inputted from a video signal line 2408 and the video signal is outputted to a pixel portion 2401 in accordance with the sampling pulse. Then, the signal is sequentially inputted to pixels of the row selected by a gate line driver circuit 2402.

Note that, as described above, a transistor of the invention may be any type of transistor, and formed over any substrate. Therefore, all circuits shown in FIGS. 23 and 24 may be formed over a glass substrate, a plastic substrate, a monocrystalline substrate, an SOI substrate, or the like. Alternatively, a portion of the circuits in FIGS. 23 and 24 may be formed over a certain substrate, and another portion of the circuits in FIGS. 23 and 24 may be formed over another substrate. That is, the whole circuits in FIGS. 23 and 24 are not required to be formed over the same substrate. For example, in FIGS. 23 and 24, the pixel portion 2301 and the gate line driver circuit 2302 may be formed over a glass substrate using TFTs, and the signal line driver circuit 2310 (or a portion thereof) may be formed over a monocrystalline substrate as an IC chip, and then the IC chip may be mounted on a glass substrate by connecting by COG (Chip On Glass). Alternatively, the IC chip may be connected to the glass substrate by using TAB (Tape Auto Bonding) or a printed substrate.

Note that the details described in this embodiment mode correspond to that using the details described in Embodiment Modes 1 to 4. Therefore, the details described in Embodiment Modes 1 to 4 can be applied to this embodiment mode.

### Embodiment Mode 6

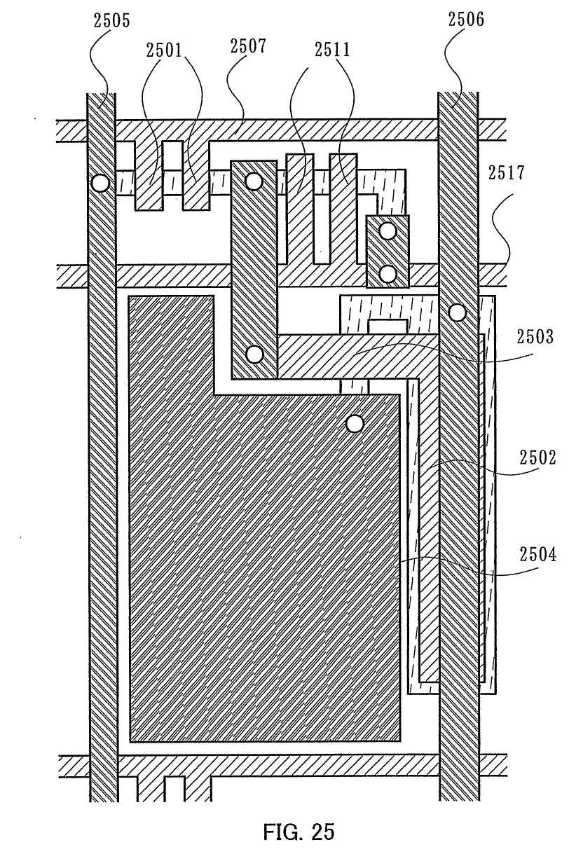

Subsequently, description is made on a layout of a pixel in a display device of the present invention. As an example, FIG. 25 shows the layout view of a circuit configuration shown in FIG. 22. Note that a circuit configuration and a layout view are not limited to FIGS. 22 and 25.

A select transistor 2501, a driving transistor 2503, a diode connected transistor 2511, an electrode 2504 of a display element are arranged. A source and a drain of the select transistor 2501 are connected to a signal line 2505 and a gate of the driving transistor 2503 respectively. A gate of the select transistor 2501 is connected to a first gate line 2507. A source and a drain of the driving transistor 2503 are connected to a power source line 2506 and the electrode 2504 of the display element respectively. The diode connected transistor 2511 is connected to the gate of the driving transistor 2503 and a second gate line 2517. A storage capacitor 2502 is connected between the gate of the driving transistor 2503 and the power source line 2506.

The signal line 2505 and the power source line 2506 are formed of a second wiring, and the first gate line 2507 and the second gate line 2517 are formed of a first wiring.

In the case of a top gate structure, a substrate, a semiconductor layer, a gate insulating film, a first wiring, an interlayer insulating film, and a second wiring are formed in this order. In the case of a bottom gate structure, a substrate, a first wiring, a gate insulating film, a semiconductor layer, an interlayer insulating film, and a second wiring are formed in this order.

Note that the details described in this embodiment mode can be implemented by freely combining with the details described in Embodiment Modes 1 to 5.

### Embodiment Mode 7

In this embodiment mode, description is made on hardware for controlling a driving method described in Embodiment Modes 1 to 6.

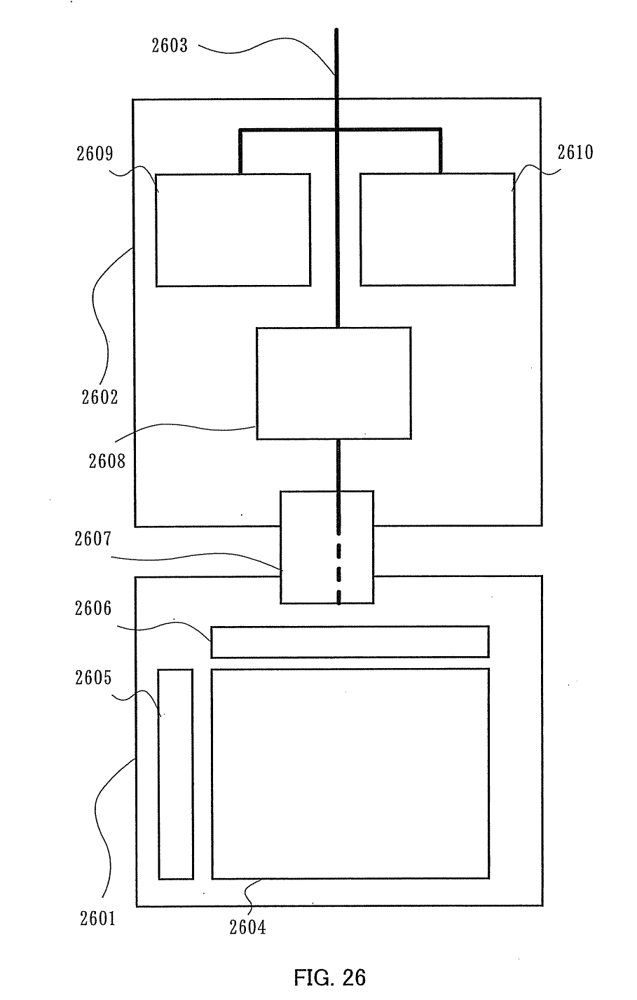

FIG. 26 shows a brief view of a structure. A pixel portion 2604 is mounted on a substrate 2601, and a signal line driver circuit 2606 and a gate line driver circuit 2605 are often mounted on the substrate. Besides, a power source circuit, a precharge circuit, a timing generating circuit, and the like may be mounted on the substrate. However, the signal line driver circuit 2606 and the gate line driver circuit 2605 may not be mounted on the substrate. In such a case, a circuit which is not formed on the substrate 2601 is often formed in an IC. The IC is often mounted on the substrate 2601 by COG (Chip On Glass). Alternatively, an IC is mounted on a connect substrate 2607 for connecting a peripheral circuit substrate 2602 to the substrate 2601 in some cases.

A signal 2603 is inputted to the peripheral circuitry substrate 2602, and a controller 2608 controls so that a signal is stored in a memory 2609, a memory 2610, or the like. In the case where the signal 2603 is an analog signal, after an analog-digital conversion is performed, it is often stored in the memory 2609, the memory 2610, or the like. The controller 2608 outputs a signal to the substrate 2601 by using a signal stored in the memory 2609, the memory 2610, or the like.

In order to realize driving methods described in Embodiment Modes 1 to 6, the controller 2608 controls such as the order in which subframes appear, and outputs signals to the substrate 2601.

Note that the details described in this embodiment mode can be implemented by freely combining with the details described in Embodiment Modes 1 to 6.

### Embodiment Mode 8

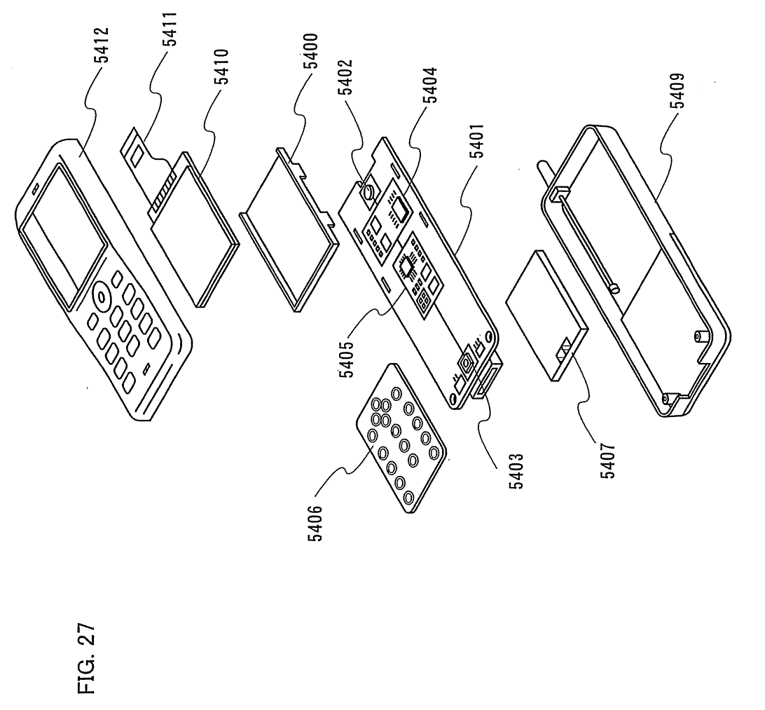

Description is made on an example of a structure of a mobile phone having a display device according to a display device or a driving method of the present invention as a display portion with reference to FIG. 27.

A display panel 5410 is incorporated in a housing 5400 such that it can be freely attached or detached. The shape and size of the housing 5400 can be changed appropriately in accordance with the size of the display panel 5410. The housing 5400 to which the display panel 5410 is fixed is fitted in a printed substrate 5401 so that it is constructed as a module.

The display panel 5410 is connected to the printed substrate 5401 through an FPC 5411. A signal processing circuit 5405 including a speaker 5402, a microphone 5403, a transmission/reception circuit 5404, a CPU, a controller and the like is mounted on the printed substrate 5401. The aforementioned module, an input means 5406, and a battery 5407 are combined to be incorporated in housings 5409 and 5412. A pixel portion of the display panel 5410 is disposed to be seen from an opening window of the housing 5409.

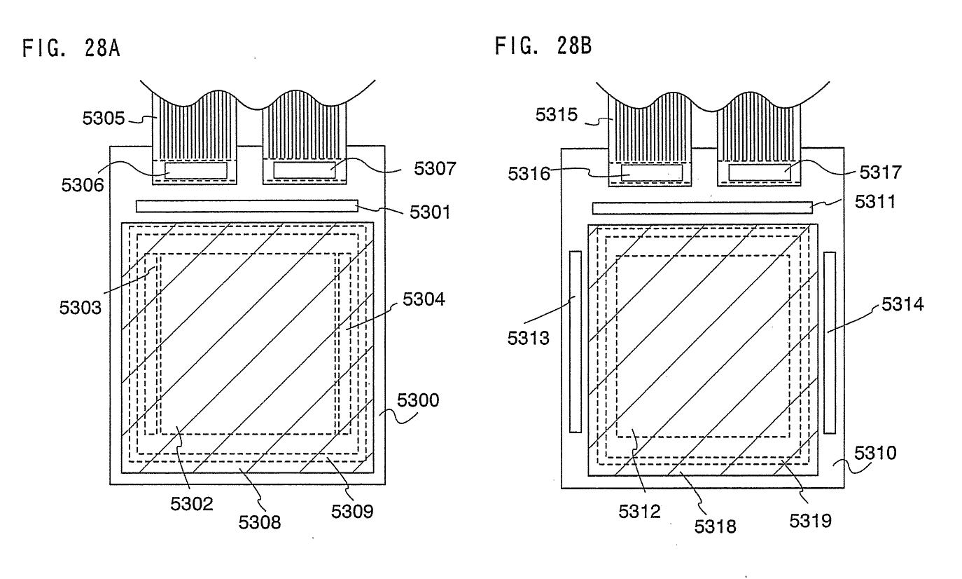

In the display panel 5410, a pixel portion and a portion of a peripheral driver circuit (a driver circuit of which operation the frequency is low out of a plurality of driver circuits) may be formed over a substrate using a TFT. Meanwhile, another portion of the peripheral driver circuit (a driver circuit of which operation the frequency is high out of the plurality of driver circuits) may be formed over an IC chip, and then the IC chip may be mounted on the display panel 5410 by COG (Chip On Glass). Alternatively, the IC chip may be connected to a glass substrate by using TAB (Tape Auto Bonding) or a printed substrate. Note that FIG. 28A shows an example of a structure of a display panel where a portion of a peripheral driver circuit and the pixel portion are formed over the same substrate and an IC chip on which another portion of the other peripheral driver circuit is mounted is connected thereto by COG, or the like. Note that the display panel of FIG. 28A is constituted of a substrate 5300, a signal line driver circuit 5301, a pixel portion 5302, a scan line driver circuit 5303, a scan line driver circuit 5304, an FPC 5305, an IC chip 5306, an IC chip 5307, a sealing substrate 5308, and a sealing material 5309. By employing such a structure, power consumption of a display device is to be lowered and the operating time of a mobile phone by charging once can be extended. In addition, the cost of a mobile phone can be reduced.

Further, by impedance converting a signal which is inputted to a scan line or a signal line by a buffer, a writing period of one row of pixels can be shortened. Therefore, a highly defined display device can be provided.

Further, as shown in FIG. 28B, a pixel portion may be formed over a substrate using a TFT, all peripheral driver circuit may be formed over an IC chip, and then the IC chip may be mounted on a display panel by COG (Chip On Glass), or the like. Note that a display panel of FIG. 28B is constituted of a substrate 5310, a signal line driver circuit 5311, a pixel portion 5312, a scan line driver circuit 5313, a scan line driver circuit 5314, an FPC 5315, an IC chip 5316, an IC chip 5317, a sealing substrate 5318, and a sealing material 5319.

By using a display device of the present invention and a driving method thereof, a clear image can be displayed, in which pseudo contour is reduced. Therefore, an image of which gray scales subtly change such as a human skin can be displayed finely.

Further, a structure described in this embodiment is an example of a mobile phone so that a display device of the present invention can be applied to various mobile phones.

### Embodiment Mode 9

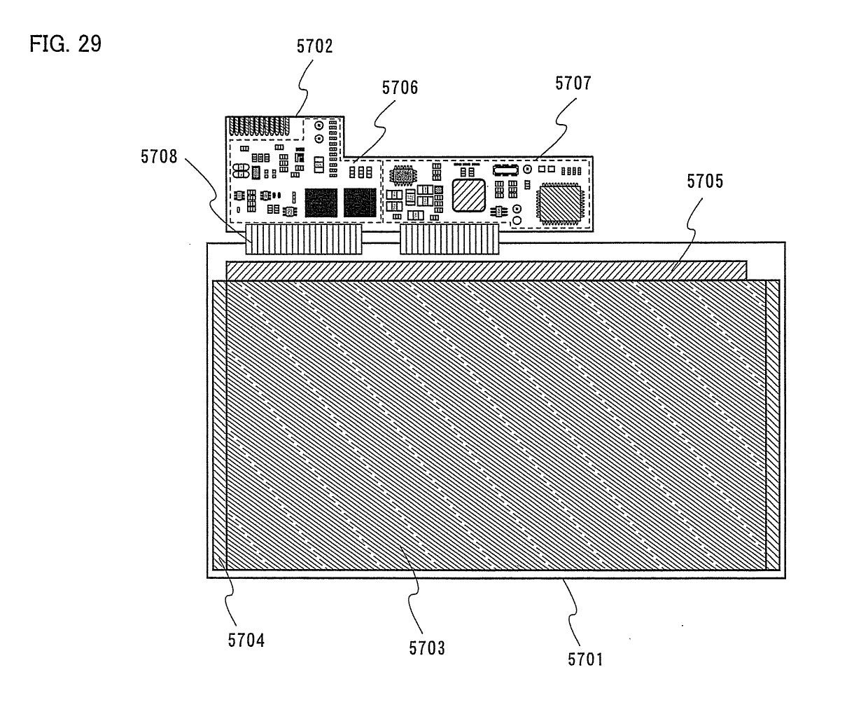

FIG. 29 shows an EL module formed by combining a display panel 5701 and a circuit substrate 5702. The display panel 5701 includes a pixel portion 5703, a scan line driver circuit 5704, and a signal line driver circuit 5705. For example, a control circuit 5706, a signal dividing circuit 5707, and the like are mounted on the circuit substrate 5702. The display panel 5701 is connected to the circuit substrate 5702 by a connecting wiring 5708. An FPC or the like can be used for the connecting wiring.

The control circuit 5706 corresponds to the controller 2608, the memory 2609, and the memory 2610 in Embodiment Mode 7. Mainly, the control circuit 5706 controls the order in which subframes appear.

In the display panel 5701, a display portion and a portion of a peripheral driver circuit (a driver circuit of which operation the frequency is low out of a plurality of driver circuits) may be formed over the same substrate using a TFT. Meanwhile, another portion of the peripheral driver circuit (a driver circuit of which operation the frequency is high out of the plurality of driver circuits) may be formed over an IC chip, and then the IC chip may be mounted on the display panel 5701 by COG (Chip On Glass), or the like. Alternatively, the IC chip may be mounted on the display panel 5701 by using TAB (Tape Auto Bonding) or a printed substrate. Note that FIG. 28A shows an example of a structure of a display panel where a portion of a peripheral driver circuit and the pixel portion are formed over the same substrate and an IC chip on which another portion of the other peripheral driver circuit is mounted is connected thereto by COG (Chip On Glass), or the like.

Further, by impedance converting a signal which is inputted to a scan line or a signal line by a buffer, a writing period of one row of pixels can be shortened. Therefore, a highly defined display device can be provided.

Further, a pixel portion may be formed over a glass substrate using TFTs, all signal line driver circuit may be formed over an IC chip, and then the IC chip may be mounted on a display panel by COG (Chip On Glass), or the like.

Note that FIG. 28B shows an example of a structure of a display panel where a pixel portion is formed over a substrate and an IC chip in which a signal line driver circuit is formed is mounted on the substrate.

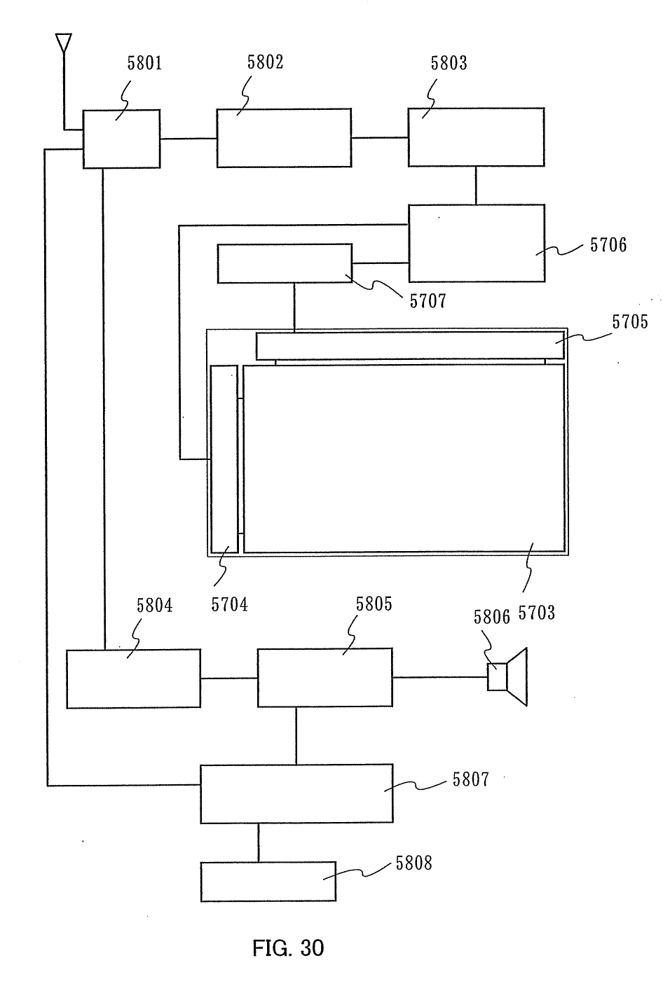

An EL television set can be completed by using this EL module. FIG. 30 is a block diagram showing a main structure of an EL television set. A tuner 5801 receives an image signal and an audio signal. The image signal is processed by an image signal amplifying circuit 5802, an image signal processing circuit 5803 for converting the image signal outputted from the image signal amplifying circuit 5802 to color signals corresponding to each of red, green, and blue, and the control circuit 5706 for converting the image signal outputted from the image signal processing circuit 5803 to be inputted to a driver circuit. The control circuit 5706 outputs a signal to each of a scan line side and a signal line side. In the case of a digital driving, the signal dividing circuit 5707 may be provided at a signal line side so that a digital signal is divided into m signals to be supplied.

An audio signal out of a signal received by the tuner 5801 is transmitted to an audio signal amplifying circuit 5804 and the outputted signal is supplied to a speaker 5806 through an audio signal processing circuit 5805. A control circuit 5807 receives control data such as a receiving station (reception the frequency) and a volume from an input portion 5808, and sends out a signal to the tuner 5801 and the audio signal processing circuit 5805.

An EL display module is incorporated in a housing so as to complete a television set. With the EL module, a display portion can be formed. In addition, a speaker, a video input terminal and the like are appropriately provided.

It is needless to say that the present invention can be applied not only to a television set but to various applications such as particularly large area display media typified by a monitor of a personal computer, an information display panel at train stations, airports and the like, and an advertising display panel on the streets.

By using a display device of the present invention and a driving method thereof, a clear image can be displayed, in which pseudo contour is reduced. Therefore, an image of which gray scales subtly change such as a human skin can be displayed finely.

### Embodiment Mode 10

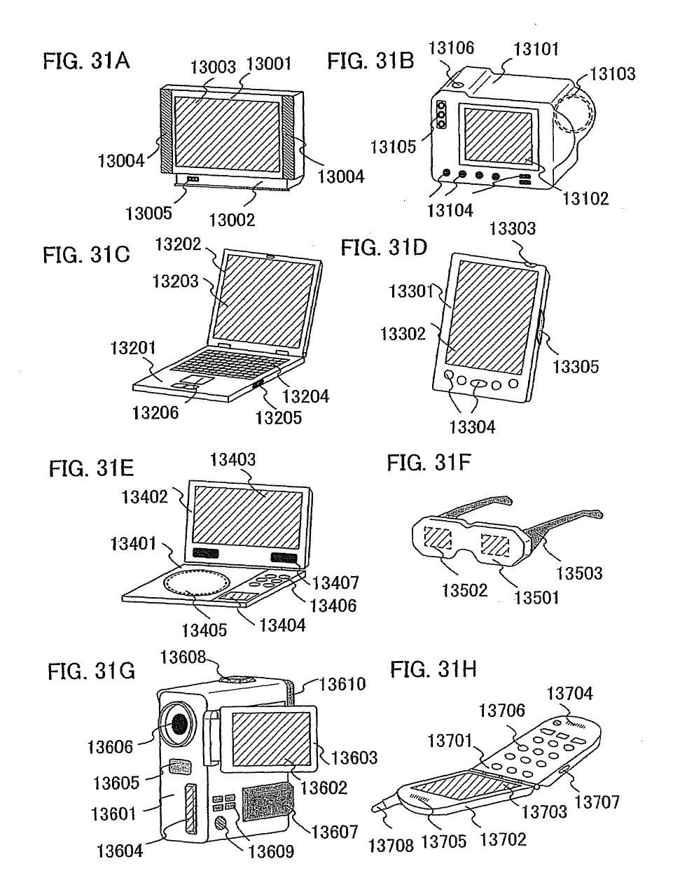

As examples of an electronic appliance to which the invention is applied, there are a camera such as a video camera and a digital camera, a goggle type display, a navigation system, an audio reproducing device (car audio component stereo, audio component stereo or the like), a computer, a game machine, a portable information terminal (mobile computer, mobile phone, mobile game machine, an electronic book, or the like), an image reproducing device having a recording medium (specifically, a device for reproducing a recording medium such as a digital versatile disk (DVD) and having a display for displaying the reproduced image), and the like. Specific examples of these electronic appliances are shown in FIGS. 31A to 31H.

FIG. 31A is a light-emitting device which includes a housing 13001, a supporting base 13002, a display portion 13003, speaker portions 13004, a video inputting terminal 13005, and the like. The present invention can be used for a display device having the display portion 13003. Further, by using the present invention, a clear image in which pseudo contour is reduced can be seen, and the light-emitting device shown in FIG. 31A is completed. Since the light-emitting device is self-luminous, a backlight is not required and a thinner display portion than a liquid crystal display is achieved. Note that the light-emitting device includes all display devices for displaying information such as for a personal computer, receiving television broadcasting, and displaying an advertisement.

FIG. 31B is a digital camera, which includes a main body 13101, a display portion 13102, an image receiving portion 13103, operating keys 13104, an external connection port 13105, a shutter 13106, and the like. The present invention can be used for a display device having the display portion 13102. Further, by using the invention, a clear image in which pseudo contour is reduced can be seen, and the digital camera shown in FIG. 31B is completed.

FIG. 31C is a computer, which includes a main body 13201, a housing 13202, a display portion 13203, a keyboard 13204, an external connection port 13205, a pointing mouse 13206, and the like. The present invention can be used for a display device having the display portion 13203. Further, by using the present invention, a clear image in which pseudo contour is reduced can be seen, and the light-emitting display shown in FIG. 31C is completed.

FIG. 31D is a mobile computer, which includes a main body 13301, a display portion 13302, a switch 13303, operating keys 13304, an infrared radiation port 13305, and the like. The present invention can be used for a display device having the display portion 13302. Further, by using the present invention, a clear image in which pseudo contour is reduced can be seen, and the mobile computer shown in FIG. 31D is completed.

FIG. 31E is a portable image reproducing device provided with a recording medium (specifically, a DVD reproducing device), which includes a main body 13401, a housing 13402, a display portion A 13403, a display portion B 13404, a recording medium (DVD or the like) reading portion 13405, an operating key 13406, a speaker portion 13407, and the like. The display portion A 13403 mainly displays image data, and the display portion B 13404 mainly displays text data. The present invention can be used for a display device having the display portions A 13403 and B 13404. Note that an image reproducing device provided with a recording medium includes a home-use game machine and the like. Further, by using the present invention, a clear image in which pseudo contour is reduced can be seen, and the DVD reproducing device shown in FIG. 31E is completed.

FIG. 31F is a goggle type display, which includes a main body 13501, a display portion 13502, and an arm portion 13503. The present invention can be used for a display device having the display portion 13502. Further, by using the present invention, a clear image in which pseudo contour is reduced can be seen, and the goggle type display shown in FIG. 31F is completed.

FIG. 31G is a video camera, which includes a main body 13601, a display portion 13602, a housing 13603, an external connection port 13604, a remote control receiving portion 13605, an image receiving portion 13606, a battery 13607, an audio inputting portion 13608, operating keys 13609, an eye piece portion 13610, and the like. The present invention can be used for a display device having the display portion 13602. Further, by using the present invention, a clear image in which pseudo contour is reduced can be seen, and the video camera shown in FIG. 31G is completed.

FIG. 31H is a mobile phone, which includes a main body 13701, a housing 13702, a display portion 13703, an audio inputting portion 13704, an audio outputting portion 13705, an operating key 13706, an external connection port 13707, an antenna 13708, and the like. The present invention can be used for a display device having the display portion 13703. Note that the current consumption of the mobile phone can be suppressed by displaying white text on a black background in the display portion 13703. Further, by using the present invention, a clear image in which pseudo contour is reduced can be seen, and the mobile phone shown in FIG. 31H is completed.

When a light emitting material with high luminance is used, a light including outputted image data can be expanded and projected by a lens and the like to be used for a front or rear projector.

Furthermore, the aforementioned electronic appliances are becoming to be used for displaying data distributed through a telecommunication line such as Internet, a CATV (cable television system), and in particular for displaying moving image data. A light emitting device is suitable for displaying moving images since a response of the light emitting material is extremely quick.

In a light emitting device, a portion that emits light consumes power. Therefore, it is desirable to display information such that the light emitting portion is as small as possible. Accordingly, in the case where the light emitting device is used for a display portion that mainly displays text data, such as a portable information terminal, in particular, a mobile phone or an audio reproducing device, it is desirable to drive so that light emitting portions display text data while non-light-emitting portions serve as the background.

As described above, the application range of the invention is so wide that the invention can be applied to electronic appliances of every field. For the electronic appliances in this embodiment mode, a display device having any of the structures shown in Embodiment Modes 1 to 9 may be used.

This application is based on Japanese Patent Application serial no. 2004-380196 filed in Japan Patent Office on 28, Dec. 2004, the entire contents of which are hereby incorporated by reference.

1-10. (canceled)

11. An electronic appliance comprising:
a substrate;
a memory;
an antenna;
a battery;
a circuit being configured to input an initialization signal to a pixel portion; and
the pixel portion comprising a plurality of pixels over the substrate, the pixel portion comprising:
a gate signal line;
a source signal line;
a transistor, wherein one of a source and a drain of the transistor is connected to the source signal line; and
a capacitor connected to the other of a source and a drain of the transistor, the capacitor including a first conductive layer using the same material as a gate of the transistor and a second conductive layer using the same material as the source signal line;
wherein the circuit is configured to input a signal to the pixel more than once so that gray scale of the pixel is expressed;
wherein the electronic appliance is an electronic book;
wherein the electronic appliance is portable; and
wherein the electronic appliance is used for displaying data distributed through a telecommunication line.

12. The electronic appliance according to claim 11, wherein the transistor is multi-gate transistor.

13. The electronic appliance according to claim 11, wherein the transistor is a thin film transistor.

14. The electronic appliance according to claim 11, wherein the substrate is a glass substrate.

15. The electronic appliance according to claim 11, wherein the substrate is a plastic substrate.

16. The electronic appliance according to claim 11, wherein the transistor includes semiconductor film is amorphous silicon.

17. The electronic appliance according to claim 11, wherein the transistor includes polycrystalline silicon.

18. An electronic appliance comprising:
a substrate;
a memory;
a circuit being configured to input an initialization signal to a pixel portion; and
the pixel portion comprising a plurality of pixels over the substrate, the pixel portion comprising:
a gate signal line;
a source signal line;
a transistor, wherein one of a source and a drain of the transistor is connected to the source signal line; and
a capacitor connected to the other of a source and a drain of the transistor, the capacitor including a first conductive layer using the same material as a gate of the transistor and a second conductive layer using the same material as the source signal line;
wherein the circuit is configured to input a signal to the pixel more than once so that gray scale of the pixel is expressed;
wherein the electronic appliance is an electronic book;
wherein the electronic appliance is portable; and
wherein the electronic appliance is used for displaying data distributed through a telecommunication line.

19. The electronic appliance according to claim 18, wherein the transistor is multi-gate transistor.

20. The electronic appliance according to claim 18, wherein the transistor is a thin film transistor.

21. The electronic appliance according to claim 18, wherein the substrate is a glass substrate.

22. The electronic appliance according to claim 18, wherein the substrate is a plastic substrate.

23. The electronic appliance according to claim 18, wherein the transistor includes semiconductor film is amorphous silicon.

24. The electronic appliance according to claim 18, wherein the transistor includes polycrystalline silicon.
